(19) United States
(12) Patent Application Publication
(10) Pub. No.: US 2002/0178039 A1
(43) Pub. Date: Nov. 28, 2002

(54) Accelerated tax reduction platform

(76) Inventor: Diane M. Kennedy, Sparks, NV (US)

Correspondence Address: Squire, Sanders & Dempsey L.L.P., Two Renaissance Square, Suite 2700, 40 North Central Avenue, Phoenix, AZ, 85004-4498, US

(21) Appl. No.: 10/153,093

(22) Filed: May 22, 2002

Related U.S. Application Data
(60) Provisional application No. 60/292,652, filed on May 22, 2001.

(51) Int. Cl. G06F 17/60

(52) U.S. Cl. 705/7; 705/31

(57) ABSTRACT

Methods and systems are disclosed for reducing a tax burden, one such method including: developing a tax strategy to determine an estimated projected tax, implementing the tax strategy, reviewing results of the implemented tax strategy for changes in taxpayer circumstances and tax laws, determining whether to update the tax strategy based on the reviewed results. Developing the tax strategy may include: collecting taxpayer information, processing the collected information to determine a suggested tax strategy, and determining action items to implement the suggested tax strategy. Implementing the tax strategy may include: developing a list of specific steps to implement the action items, and determining a timeline for performing the specific steps. A system for selecting appropriate business entities based on taxpayer circumstances is also disclosed. The invention also discloses computer programs and systems for reducing a tax burden.

### CROSS REFERENCE TO RELATED APPLICATIONS

This application claims the benefit of U.S. Provisional Application No. 60/292,652, filed on May 22, 2001, incorporated herein by its reference.

### COPYRIGHT NOTICE AND AUTHORIZATION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

1. Field of the Invention.

The present invention generally relates to methods and systems of reducing taxes for businesses, business owners, and/or investors. More particularly, the invention relates to developing, implementing and/or maintaining tax strategies.

2. Related Art.

Business owners and businesses often utilize the services of a tax practitioner to assist in planning and preparing tax returns. The emphasis in the tax field is conventionally focused on historical compliance issues. In essence the tax practitioner concentrates on accuracy and deadlines for tax preparation of tax returns within the guidelines of tax laws and regulations. Conventionally, if tax planning exists at all for average business owners or investors, it is typically done after formation of businesses and in a non-systematic haphazard fashion. The lack of a standardized system for preparation, implementation and maintenance of a tax strategy often results in tax plans that: (1) may not adequately address the clients needs and goals; (2) may not be set in place in a legal or efficient manner; and (3) may not be systematically updated as laws and taxpayer circumstances change.

Tax attorneys and Certified Public Accountants (CPAs), however, may develop customized tax strategies for wealthy clients. This type of tax planning is specially tailored for these clients by re-designing the tax plan periodically, e.g., once a year. However, the lack of a systematic and consistent system for tax planning makes this approach very expensive. Accordingly this type of customized tax planing is not typically used by average business owners.

Additionally, business owners have no comprehensive program for implementing tax strategies even if they do have a tax strategy. For example, it is typically the responsibility of the business owner to coordinate with their CPAs, attorneys, corporate administrators, financial planners and others to implement a designed tax strategy. Frequently, the business owner does not “speak the language” of these professionals and because of a lack of understanding by the business owner, the plans may not be implemented properly.

Tax laws include the IRS code, Treasury Regulations, Revenue Procedures, Revenue Rulings, Private Letter Rulings and Tax Court cases. Since this substantial body of information is frequently modified on a daily basis, tax strategies and implementations must be regularly evaluated for compliance with modifications in the tax laws. Moreover, business owner circumstances and goals may change which necessitates changes in their tax strategy. There is currently no systemized method for updating tax strategies to account for these types of changes.

### SUMMARY OF THE INVENTION

The present invention discloses methods, systems and computer programs addressing at least one of the aforementioned problems. One method of the preferred embodiment includes: (1) developing a tax strategy based on information provided by a taxpayer to determine a tax strategy that will reduce estimated projected tax based on the most likely assumptions regarding income and expenses for the taxpayer at both a personal (individual) level and business level; (2) implementing the developed tax strategy; (3) periodically reviewing results of the implemented tax strategy for changes in financial circumstances and tax laws; and (4) determining whether to update the implemented strategy based on the reviewed results.

Additional aspects of the invention relate to, among other things, methods and systems for characterizing income and assets, discovering tax deductions and deductible benefits, moving income from higher taxed entities to lower taxed entities, determining business exit strategies, evaluating funding sources for businesses, assessing risk factors and evaluating business entities for utilization.

### BRIEF DESCRIPTION OF THE DRAWING

Further aspects and advantages of the present invention will become apparent from the following description of the invention in reference to the appended drawing wherein like references denote like elements and in which:

FIG. 1 is a flow diagram illustrating a method of reducing taxes according to one preferred embodiment of the invention;

FIG. 2 is a flow diagram illustrating development of a tax strategy of the method shown in FIG. 1;

FIG. 3 is a flow diagram illustrating implementation of a developed tax strategy of the method shown in FIG. 1;

FIG. 4 is a flow diagram illustrating reviewing the implemented tax strategy of the method shown in FIG. 1;

FIG. 5 is a flow diagram illustrating determining whether to update the reviewed tax strategy of the method shown in FIG. 1;

FIG. 6 is a flow diagram illustrating a method for reducing taxes according to a second preferred embodiment of the invention;

FIG. 7 is a flow diagram illustrating a method for characterizing income and assets according to the present invention;

FIG. 8 is a flow diagram illustrating a method of discovering potential tax deductions for personal expenditures according to the present invention;

FIG. 9 is a flow diagram illustrating a method of determining potential tax deductions for business expenditures according to the present invention;

FIG. 10 is a flow diagram illustrating a method of moving income from a higher tax bracket to a lower tax bracket according to the present invention;

FIG. 11 is a flow diagram illustrating a method of determining a strategy for exiting a business according to the present invention;

FIG. 12 is a flow diagram illustrating a method of determining business funding sources according to the present invention;

FIG. 13 is a flow diagram illustrating a method of assessing risks and risk tolerance according to the present invention;

FIG. 14 is a flow diagram illustrating a method for evaluating and selecting business entities according to the present invention;

FIGS. 15A-15C are a flow diagram illustrating a method for selecting business entities according to a preferred embodiment of the present invention;

FIG. 16 is a block diagram illustrating a computer-based system of the present invention; and

FIG. 17 is a block diagram illustrating a network-based system of the present invention.

### DETAILED DESCRIPTION OF THE PREFERRED EMBODIMENTS

A method for reducing taxes according to a preferred embodiment of the invention provides a systematic process of developing, implementing and maintaining a tax strategy. The methods and systems of the present invention enable a tax practitioner to develop tax strategies for proactive tax and asset protection planning, implement developed tax strategies and update tax strategies due to changes in taxpayers circumstances and/or tax law.

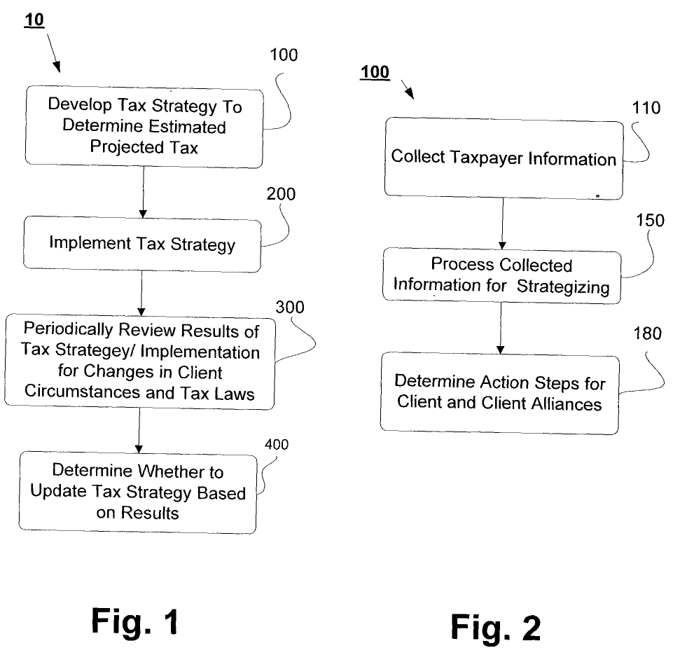

Referring to FIG. 1, a preferred method for reducing taxes 10 includes: (i) developing a customized tax strategy based on client information to determine an estimated projected tax 100; (ii) implementing the developed tax strategy 200; (iii) reviewing results of the implemented tax strategy on a periodic basis 300; and (iv) maintaining the implemented tax strategy by determining whether to update the implemented tax strategy based on reviewed results 400.

As used herein, the term “client” means any individual, group of individuals or entity utilizing the accelerated tax reduction platform and/or methods described herein. This term is not intended to limit the invention's use by or for any paying or non-paying entity. For example, “client” may be synonymous with a “user” in computer-related embodiments of the present invention. Additionally the term “tax strategist” is not intended to designate any specific entity in a limiting manner and may include for example, tax advisors, accountants, lawyers, firms and companies or any combination thereof. In fact, “tax strategist” may also mean a computer and/or software used for the accelerated tax reduction platform disclosed by the present invention.

A method 100 of developing a tax strategy (FIG. 2) for a client begins with the collection of information 110 relevant to personal and business income and assets and intentions of the client with respect to the business. Such information may include, for example:

(1) Client's personal current taxable income as reported on their previous Form 1040 return;

(2) Character of current income for the individual, for example, earned income, passive income and portfolio income;

(3) Carry-forward passive losses for the taxpayer;

(4) Carry-forward capital losses for the taxpayer;

(5) Personal expenses that may qualify for business deductions;

(6) Benefits provided by company eligible for C Corporation deductions;

(7) Assets owned by taxpayer/business;

(8) Assets to be purchased by taxpayer/business (projected ownership);

(9) Number of current dependents that may be employed by taxpayer and their marginal rates;

(10) Marginal tax rate for the client including and excluding business income;

(11) Investment/Spending goals of the client/business;

(12) Current business income;

(13) Type of business structure currently used (e.g., C corporation; S corporation; LLC.);

(14) Projected income from business;

(15) Type of business income (whether it qualifies as a special type of business for tax purposes, e.g., Personal Service Company income; Personal Holding Company income).

(16) Plans for proceeds from business (e.g., reinvestment into business or withdrawal from business as profit);

(17) Strategy for business owner to exit business (e.g., go public, sell business, transfer business to family members);

(18) Funding requirements for the business (e.g., whether additional funding for business will be required and where the funding will come from, i.e., capital investment by owner, borrowing for funding);

(19) Risk factors assigned to business (e.g., potential liabilities of business operation);

(20) Risk factors assigned to individual (e.g., potential for business liability to overflow to business owner);

(21) Individuals tolerance for above-noted risk factors; and

(22) Lists of current expenses for client and business.

The foregoing factors are not necessarily an exhaustive list of information collected for planning a tax strategy, but are provided as an example of information known to be relevant for the present invention. The client may require explanation for the items of solicited information. Explanations for each type of information is discussed in further detail below and may be provided to a client when needed and in any manner, such as help screens or automated tutorials on a computer.

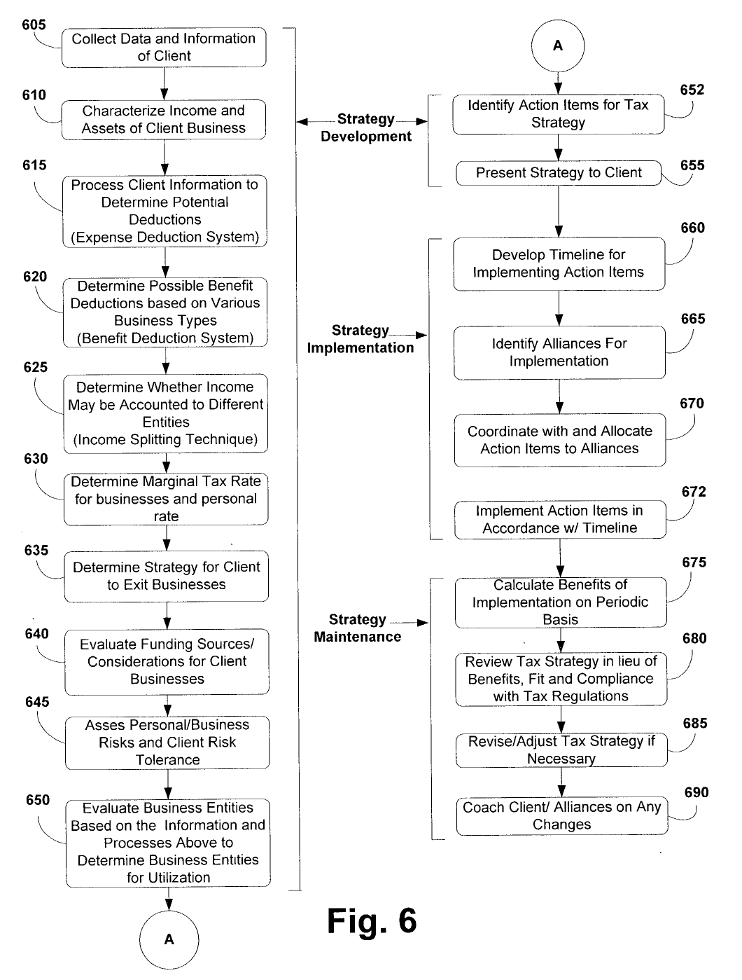

Once the relevant client information is obtained, it is processed to develop a tax strategy 150. The process of developing the tax strategy may include (i) determining advantages and disadvantages of the present client and business structures, (ii) evaluating potential alternative business and/or investment structures; (iii) determining steps for minimizing income tax to be paid by the client/client business, for example, employing dependents and paying salaries, changing business structures, forming new business entities, identifying all possible tax deductions, etc.; and/or (iv) agreeing on a proposed tax strategy. A detailed discussion of an embodiment for developing a tax strategy is discussed below with reference to FIGS. 6-15 and in the book titled “Loopholes of the Rich”™ by Diane Kennedy, C.P.A., Warner Books, Inc., June 2001, which is fully incorporated herein by reference.

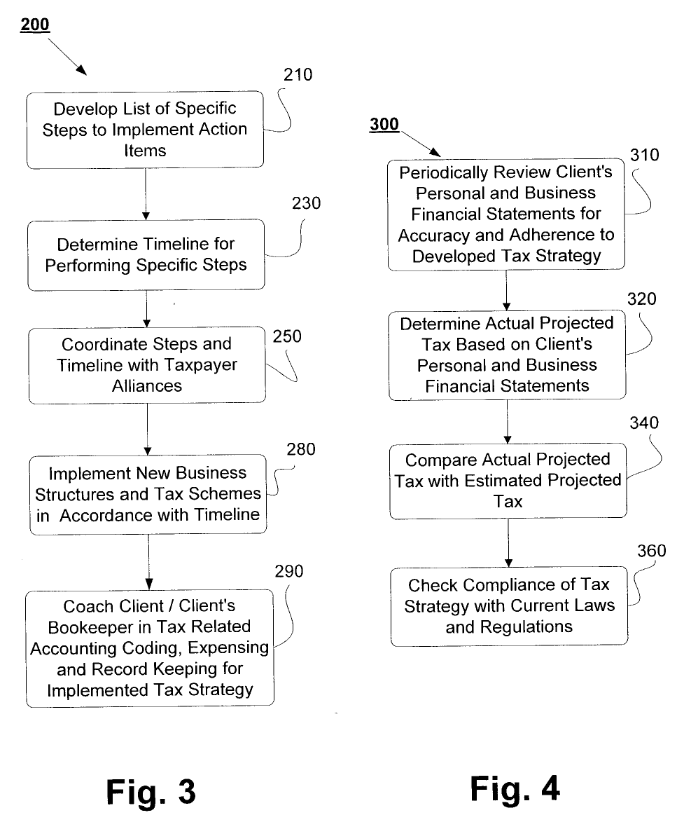

Once a proposed strategy is acceptable to the client, action items are determined for implementing the tax strategy 180. A method for implementing a tax strategy 200 is now described with reference to FIG. 3. A list is developed including specific steps for the client and/or client alliances to implement the action items of a developed tax strategy 210. Such steps may include for example, filing necessary documents for forming or converting to a new business structure. As used herein, “alliances” includes any person or entity a client may use as an advisor or to perform certain tasks on behalf of the client/client's business. Examples of alliances include, but are not limited to, attorneys, financial professionals, accountants, business advisors, and personal assistants.

A timeline is then determined for performing the specific steps 230. The client and client's alliances coordinate with each other on performing each step in accordance with the determined timeline 250. At this point, the specific steps and/or timeline for performance may be adjusted based on the ability to perform the prescribed steps and in an order necessary to perform the steps to implement action items. It should also be recognized that the timeline for performing the steps might be determined upon or after coordination with the client's alliances. Determination of the timeline may take into consideration such factors as complexity of tasks to be performed, benefits of implementation of each step before another, requirements of performing certain steps before others and availability of alliances to perform specific steps. Next, the specific steps are implemented in accordance with the determined timeline 280.

Additionally, the client and client's alliances may be coached in tax-related accounting coding, expensing and record keeping for the implemented tax strategy 290. For example, the client's bookkeeper could be coached on set-up of the client's bookkeeping records for an accounting program. The client may be coached on methods for maximizing depreciation and current expensing of repair items. In another example, the client could also be coached regarding the benefit of alternative pension plans and timing of funding.

The implemented tax strategy is periodically reviewed for changes in client/client's business circumstances and compliance with tax laws. The periodic review may be performed at anytime, on a predetermined span of time, for example, monthly, quarterly, semiannually, or yearly, and/or when significant changes occur in the client's personal or business circumstances that may affect the effectiveness of the tax strategy. The review may also be performed when changes in tax law occur that may affect the tax strategy.

A preferred method 300 for reviewing an implemented tax strategy is illustrated in FIG. 4. In this method, the client's personal and business financial statements are preferably reviewed once a month for accuracy and adherence to the developed tax strategy 310. Using the reviewed financial statements, an actual projected tax may be determined 320. As used herein, the “actual projected tax” is calculated based on current performance of the client business and client investments, whereas the “estimated projected tax” (determined before implementation of the tax strategy) takes into consideration the previous years' performance accounting for projected growth and investment. The actual projected tax is compared with the estimated projected tax to determine whether there are any significant changes 340. It should also be recognized that rather than comparing actual and estimated projected taxes, other types of financial or personal indicia may be used to determine whether relevant changes to client circumstances have occurred. For example, projected business and personal earnings may be compared with actual earnings or any comparisons made based on projected verses actual financial performance. Moreover, changes in personal circumstances may be considered as well, such as changes in marital status, new dependents, or property acquisitions. Essentially, any changes in the client's personal or business circumstances, which could affect an implemented tax strategy, may be reviewed.

The current tax strategy is also checked for compliance and/or fit with current tax laws and regulations 360. Tax laws are subject to frequent changes and thus, the tax strategy should be periodically reviewed on these changes. For example, a tax loophole, available at the time of tax strategy development, may be subsequently closed. If the tax strategy is not periodically checked for conformance with changes in tax laws, strategies based on the now invalid loophole may inadvertently lead to a client paying increased taxes, tax related expenses or penalties. The period for reviewing the tax strategy for compliance may be performed as needed, for example, annually, semi-annually, or upon significant changes in tax laws.

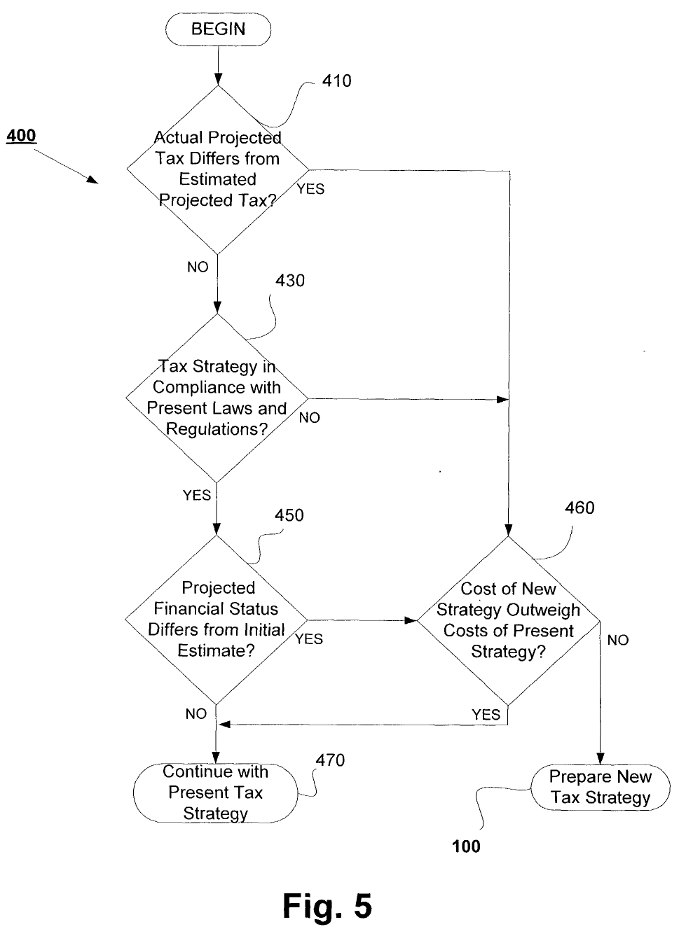

FIG. 5 illustrates a process 400 to determine whether a reviewed tax strategy should be updated or remain the same. If the actual projected tax differs significantly from the estimated projected tax 410, a new tax strategy may be developed or the current strategy modified 100. The significance of the difference between actual and estimated projected taxes may not be a constant and preferably takes into consideration the overall portfolio of the client and the related expenses involved in setting up a new tax strategy. If the expenses involved in preparing and implementing a new tax strategy exceeds the differences between the actual and estimated projected taxes 460, it may not be desirable for the client to change the current tax strategy 470. The overall portfolio of the client, among other things (e.g., client sophistication and personal taste), may also be considered in determining the significance of differences. For example, a client having a net worth of fifty million dollars may not be concerned with a ten thousand dollar difference between the estimated and actual projected taxes, whereas a client having a net worth of four hundred thousand dollars may be concerned with this difference.

Additionally, if the present tax strategy were based on tax laws that have been changed 430, a new strategy may be developed 100. Changes in tax laws may include closing of tax loopholes, opening new types of tax benefits and changing tax rates. In a manner similar to comparison 410, if the expense of changing the tax strategy outweighs the cost of proceeding with the present strategy 460, the present tax strategy may be maintained 470.

In an alternative embodiment (not illustrated), the method may include the option of developing a new tax strategy in the event of any significant change, determining the costs of implementing the new tax strategy and then deciding whether the costs of implementing the new tax strategy outweigh the costs of maintaining the current tax strategy. Since the costs of implementing a new tax strategy may significantly outweigh the costs of developing the new tax strategy, this option may be desirable to the client and provide a more informed choice for long-term benefits.

Additional financial factors such as the projected income and net worth of the client and client business may be compared to the initial estimates (used in planning the current tax strategy) to determine whether the current tax strategy is still valid. If these factors differ materially from the original estimates 450, and the cost of a new tax strategy are acceptable to the client 460 a new tax strategy may be developed 100. If these factors are insignificant changes to the original estimates 450 or the cost of a new tax strategy is not amenable to the client 460, then the current tax strategy is maintained 470.

In all cases herein, the determination of significant verses insignificant differences are ultimately determined by the client, either at the time of calculation or based on predetermined parameters established by the client and/or tax strategist.

Another preferred embodiment of the invention will now be described with reference to FIGS. 6-15. The preferred method of this embodiment may be generally separated into three phases including: (i) tax strategy development; (ii) tax strategy implementation; and (iii) tax strategy maintenance. Each phase of the accelerated tax reduction platform is described in detail below.

### TAX STRATEGY DEVELOPMENT.

In this embodiment developing a tax strategy preferably includes one or more of the following: (i) collecting client information; (ii) characterizing income and assets of client businesses; (iii) determining deductible expenses and benefit deductions; (iv) moving income from higher taxed entities to lower taxed entities; (v) determining marginal tax rates for client's personal and business income; (vi) identifying exit strategies for exiting businesses; (vii) identifying funding sources for client businesses; (viii) assessing risks and risk tolerance; (ix) determining appropriate business entities for client businesses; (x) identifying action items to implement the tax strategy; and (xi) presenting the tax strategy.

The strategy development process begins with the efficient collection of client data and information 605 and characterization of client/client business income and assets 610. In one embodiment, data and information collection 605 involves the client filling out a predefined informational package including personal and financial information of the type previously described. This information form may be in paper format, such as a booklet or in electronic format, such as a display on a computer requesting the client to input information for each respective question. The provided information is assembled and compiled by a person or processor for strategy development. It is important to realize that the information collection step may include collecting initial information and that additional information may be collected during each of the individual processes that follow. In a computer implemented embodiment of the present invention, the client or other knowledgeable entity may provide information throughout the processes of strategy development, strategy implementation and strategy maintenance.

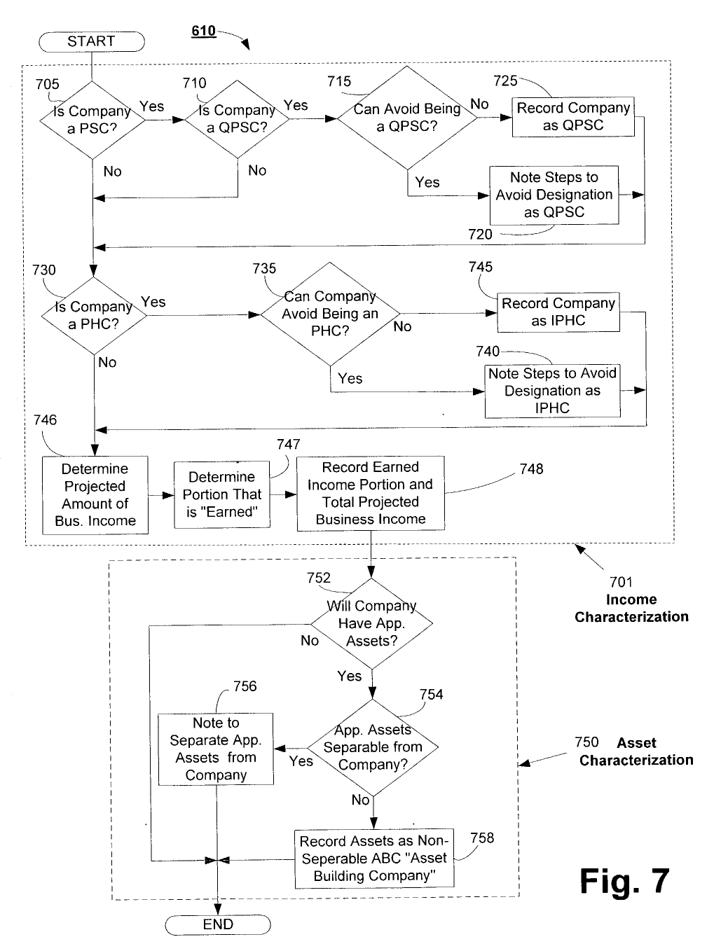

The income and assets of the client are characterized 610 by a person or processing device, preferably in accordance with the predefined method shown in FIG. 7 (discussed below). It is important to properly characterize personal and business income since tax consequences may vary based on the types of income. Currently, in the U.S., the IRS defines three basic types of income as earned income, passive income and portfolio income. While the types of income are defined by the IRS, essentially, earned income comes from a job or active trade or business, passive income is derived from investments such as rental properties, and portfolio income is derived from interest and dividends and includes as a subset, capital gains and losses. A significant aspect of the character of income is that losses from one type of income, for example capital losses, can generally only offset income in that same category, e.g., portfolio income; likewise, passive income losses (generally) may only offset passive income. Preparation of a good tax strategy includes determining where there are losses that are not being utilized and determining a way to take advantage of the losses.

Client income and assets may be characterized 610 in any manner. A preferred method for characterizing income and assets of the client is shown in FIG. 7. This process entails determining the type of business income 701 for each of the client's businesses and determining the type of assets in each respective business 750. The type of income for a business may qualify as income from three basic categories of business: (1) a Personal Service Corporation; (2) a Personal Holding Company; and (3) neither 1 or 2. The characterization of income as income from certain types of businesses triggers unfavorable tax consequences that are preferably avoided.

Most states require that professionals incorporating their practices, for example an attorney or accountant, create a professional corporation. These mandatory professional incorporation requirements may also make them Personal Service Corporations. Additionally, the IRS Code requires businesses performing work in the fields of accounting, engineering, medicine, legal, veterinary medicine and consulting to be incorporated as Personal Service Corporations. If the client business falls within one of these definitions, its income is characterized as Personal Service Corporation (PSC) income 705.

Next, it is determined whether the PSC is a Qualified Personal Service Corporation (QPSC) 710. A QPSC incorporated as a C corporation is subject to a flat tax of 35% on business income. Since this QPSC rate is higher than most marginal and corporate rates, it is desirable to avoid being a QPSC if possible.

There are two tests for determining whether or not a PSC is a QPSC: (1) If the total amount of the owner and employee's time spent on PSC activities is less than 95% of the total time spent on business activities, then the business is not a QPSC; and (2) if 5% or more of the ownership of the business is held by a non-PSC provider, the business is not a QPSC. If a business fails either of these two tests, the business is a QPSC and it is determined whether any steps may be taken by the client to avoid being a QPSC 715. Avoidance may be accomplished if the client business can or is willing to take steps to pass both tests, i.e., PSC activities lessened to <95% and transfer ownership of >5% to a non-PSC provider. If steps can be taken to avoid characterization as a QPSC, the steps are noted in a tax strategy worksheet 720. If the business cannot avoid being a QPSC, income from the business is designated as QPSC income on the tax strategy worksheet 725.

The tax strategy worksheet may be any conventional means for recording and/or storing information relevant to developing a tax strategy. In one embodiment, the information of the tax strategy worksheet is maintained in a memory device as a data file that may be accessed for later processing and/or printed for evaluation by a tax strategist. Each tax strategy worksheet may be maintained as a database file for each client business or a complete file segregated into specific components such as the client personal financial information, and each specific business owned by the client.

It is also preferable to determine whether the business meets the definition of a Personal Holding Company (PHC) 730. The IRS defines a PHC as a corporation: (1) in which 60% or more of the corporate income was personal holding income; AND (2) five or fewer individuals own 50% or more of the outstanding stock. PHC income includes dividends, interest, royalties, annuities, rents (unless they constitute 50% or more of the adjusted ordinary income) and personal service contracts where the person performing the work is specified. All other forms of income, including incomes where 50% or more of the income comes from rent are not PHC income. If the company meets the definition of a PHC, it is determined whether any steps may be taken to avoid being a PHC 735. Such steps may include adjusting income of the business to include less than 60% PHC income or adjusting ownership of the majority of the company to more than five individuals. If these steps may be taken to avoid being a PHC and the client is amenable to these actions, the steps for avoiding PHC treatment are noted on the tax strategy worksheet 740, else the company is determined to be an Irreversible PHC.

A company is an Irreversible PHC (IPHC) if the nature of the ownership (5 or fewer people holding 50% or more of the company) and the nature of the income cannot be changed to fall outside the definition of a PHC. If the client company is determined to be an IPHC, the income from the business is designated as IPHC income on the tax strategy worksheet 745. Due to the unfavorable tax consequences of treatment as a PHC, such as a flat taxable rate of 38.6% (current for year 2002) on all taxable income and the loss of the dividend reduction normally received by C Corporations, it is strongly recommended that the client change ownership of the company or create other sources of non-PHC income to avoid being a PHC.

The income characterization process may also include determining the total projected businesses income for a predetermined period of time 746, for example, three years, determining the portion of the total projected income that qualifies as “earned” income 747 and recording the portion of “earned income” along with the total projected business income 748 on the tax strategy worksheet. The total and earned income is used to determine taxable income that could potentially be, depending on business structure selected, subject to self-employment or payroll taxes. Next, the type of assets belonging to the business is characterized 750. This characterization includes determining whether the business has or will have appreciating assets 752. An appreciating asset is an asset that is held for investment, primarily for it future appreciation. Appreciating assets may include for example, long term real estate or paper assets such as stocks, bonds and mutual funds. If the business does have or will have appreciating assets, it is determined whether any appreciating assets, for example office buildings or rental properties owned by the business, may be separated from business 754. It is preferable to separate appreciating assets owned by a business into one or more separate business entities to obtain maximum tax benefits and risk protection. For example, the current individual maximum capital gains tax rate of 20% is not available for C Corporations. Gains within a C Corporation are taxed at the regular income tax rates. Therefore, it makes good sense to hold appreciated assets outside of a C Corporate structure. In the case of an operating business that could be subjected to a lawsuit due to an action of the business, it is generally advisable to have assets not held in the same ‘at risk’ business. This would also indicate that the assets should be held separately. If the appreciating assets are separable, a note to separate appreciating assets into a different business entity is recorded on the tax strategy worksheet 756, else the assets are recorded as non-separable “asset building company” or “ABC” 758.

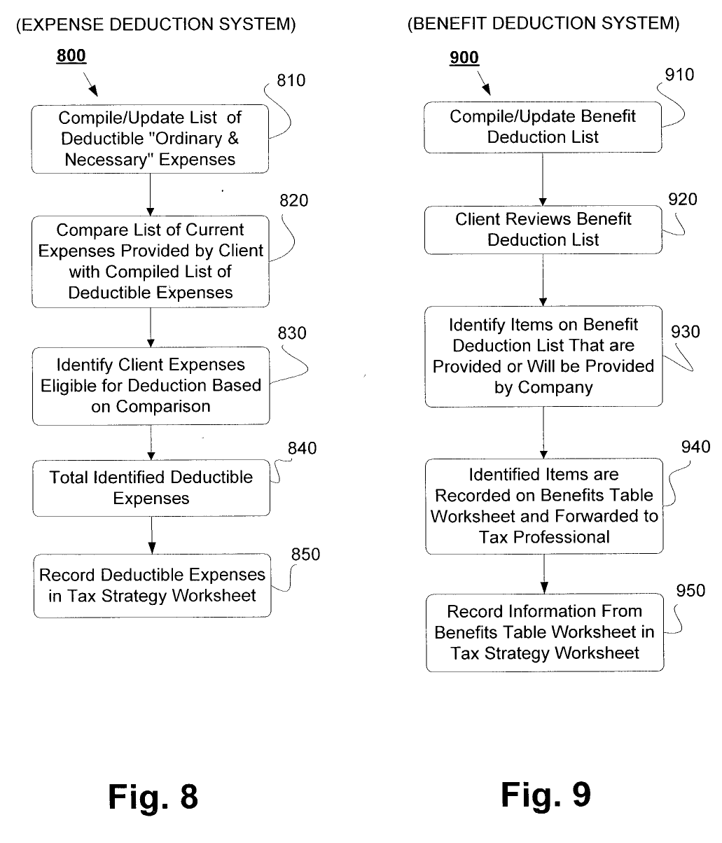

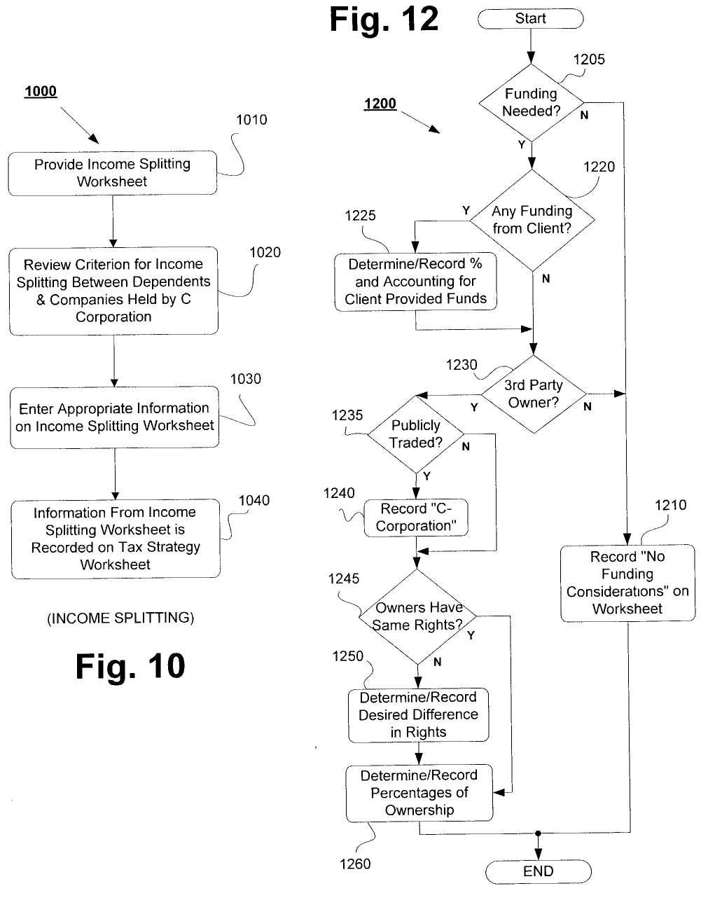

The information collected from the client may also be processed to: (1) determine potential deductions for client expenses according to an Expense Deduction System, an example of which is shown and described with reference to FIG. 8; (2) determine possible employee benefit and charity deductions based on various types of businesses preferably using a Benefit Deduction System, an example of which is shown and described with reference to FIG. 9; and (3) determine whether client/business income may be accounted to different entities at a lower tax rate to reduce the adjusted gross income of the client. Accounting to different entities at lower tax rates is preferably performed using an Income Splitting Technique, and example of which is described below in reference to FIG. 10.

The client data and information is preferably processed to determine potential tax deductions for client expenses 615. As shown in FIG. 8, a preferred method of determining client expenditures that may qualify as business deductions is referred to herein as an “Expense Deduction System” and includes: (i) compiling/updating a list of “ordinary & necessary” expenses definition as defined by current tax law; (ii) reviewing the compiled list and identifying client expenses that may qualify for deduction; (iii) totaling the dollar value of the identified deductible client expenses; and (iv) recording the identified deductible expenses and the total dollar value in the tax strategy worksheet.

The tax code allows for a deduction for all the ordinary and necessary expenses paid or incurred during a taxable year in carrying on any trade or business. The IRS does not define “ordinary” or “necessary” in the tax code and thus, it is left to a tax practitioner or client to discover through review of tax court decisions. A tax professional may review and compile a comprehensive list of potential business expense deductions and corresponding circumstances that have been found to be acceptable by the tax courts 810. This compiled list may be recorded in a document or stored in an electronic storage medium, for example in a database stored in a memory device. It should be noted that the list might not have to be compiled more than once. Once compiled, the list may be reused and/or updated, to reflect changes or additions to available deductions.

Preferably, the client provides a list of current expenses during the data and information collection process 605. The tax strategist, client, alliance or a computer processing device compares the compiled list with the client provided list 820, and all client expenditures fitting the legal definition of “ordinary” and “necessary” expenses are identified 830. The dollar value of identified deductions is totaled 840 and the value and each deduction are entered into the tax strategy worksheet 850.

Processing the client information may further include identifying deductions for business provided benefits based on the various types of business categories 620. A preferred method for identifying benefit and inventory deductions is shown in FIG. 9 and is referred to herein as the Benefit Deduction System. The method preferably includes: (i) compiling/updating a benefit deduction list 910; (ii) reviewing the list for benefits provided by the client; (iii) identifying deductible benefits based on the review; and (iv) recording the identified deductible benefits.

The benefit deduction list is a compilation of the types of benefits provided by businesses that are subject to at least partial income tax deductions. The benefits qualifying for tax deduction as well as the regulations for each offered deduction are specified in the IRS code. An example of the benefit deduction list is as follows:

### EXAMPLE 1

1. Health Insurance: 100% deductible in C corporation, restricted in all other business categories;

2. Disability Insurance: 100% deductible in C corporation only;

3. Annual Medical Checkups: may be expensed to the C corporation and provided tax-free to employees;

4. Personal Liability Insurance: for example, Errors and Omissions Insurance for employees and Director's Insurance covering mistakes by directors are deductible for C corporations;

5. $5000 Death Benefit: is 100% deductible for C corporations;

6. Small Christmas Gifts: given to employees may be deducted for C corporations;

7. Subscriptions to Business Periodicals: are deductible for any business category;

8. Payment of Professional and Business Club Dues: are available for any business type;

9. Cost of Business Conventions: including travel, hotel and meals associated with the convention are deductible for any business type;

10. De Minimis Fringes: are deductions for property or services provided to beneficial employees of C corporations where the value of the property or service is so small as to make accounting for it unreasonable or impracticable (e.g. Thanksgiving turkeys, Christmas gifts);

11. Uniform and Small Tools: includes clothing and its cleaning that is deductible by any business type if it is a uniform related. The C corporation may deduct small tools given to employees to assist them in their jobs;

12. Non-qualified Achievement Awards: are deductions available for C corporations for providing property (not cash) awards to employees of up to $400;

13. Recreation and Health Facilities: are deductions available to C corporations for costs involved in providing an “on-premise” athletic facility;

14. Prepaid Legal Assistance: applies to C corporations for deducting the cost of a qualified group legal services plan;

15. Tuition Reimbursement Plans: applies to C corporations that can deduct up to $5,250 in annual tax-free assistance to each eligible employee;

16. Meals Expense Provided to Employees: is deductions a C corporation can take for providing means to employees by providing occasional and sporadic meal reimbursements and supper money for overtime work. The same deduction is available for S corporations, but is not allowed for any shareholder who holds more than a 2% interest in the company;

17. Medical Reimbursement Plans: includes deductions a C corporation or Schedule C business can take for providing medical reimbursement expenses to employees such as co-pays, prescription drugs, dental, vision and other medical expenses;

18. Child and Dependent Care: is a deduction available to C corporations of up to $5,000 dollars per employee for expenses paid to the employee for care of dependents under 13 and physically or mentally challenged dependents of the employee that are incapable of self-care;

19. $50,000 Group-Term Insurance: is deductible for any type of business when provided at the expense of the company to employees;

20. $2000 Group-Term Insurance for Dependents: is deductible by any type of business when providing insurance to cover employees dependents;

21. Qualified Achievement Awards: is a deductible employee achievement award (for longevity or safety) provided by a C corporation under an established written plan or program that provides up to $1600 per year in total awards; and

22. Inventory: is a deduction for C corporations up to twice the basis of inventory or other ordinary income property that has been contributed to a qualifying charity that provides for the needy (this means that outdated or no longer useful inventory may be contributed to a qualifying charity for a deduction of twice its value).

The benefit deduction list is preferably provided to the client during the data and information collection process 605. The client (or knowledgeable company representative) reviews the benefit deduction list 920, and identifies items on the list corresponding to those benefits provided by the client's company 930 as well as benefits that may be offered in the future. Identified benefits are recorded on a provided benefits table worksheet 940 and preferably include, the name of the benefit provided by the business, the projected dollar amount per year spent on the benefit and the type of business that qualifies to deduct the identified benefit. The benefits table worksheet is used to determine the estimated projected tax and identify whether the company should consider changing to a different business structure. The identified items on the provided benefits table worksheet are recorded on the worksheet for preparing the tax strategy 950. It should be noted that the benefits table worksheet might be part of the tax strategy worksheet in paper or electronic form.

Further processing of the client data and information is performed to determine whether income may be accounted to different entities 625 (FIG. 6). A preferred method 1000 for determining this is referred to herein as an “Income Splitting Technique” and is discussed below in reference to FIG. 10. Income splitting essentially splits income between two or more tax brackets. Examples of splitting income between tax brackets include moving income that typically goes to the high income earner, for example, the business owner, to his/her: (a) dependent children that can be employed in their business; (b) businesses held within a C corporation; and/or (c) dependent parents, spouses or other dependents. In order to split income between tax brackets, a salary paid to a lower bracket entity, for example a dependent child, cannot be more than a reasonable salary for a particular type of employ. By way of example, $100,000 salary for a dependent child maintaining office plants may not be a reasonable salary.

The Income Splitting Technique 1000 of a preferred embodiment begins by providing the client with an income splitting worksheet that allows input for dependent names, ages, job titles and the salary paid to these dependents 1010. The method continues by reviewing the criterion for income splitting 1020 and entering the appropriate information on the income splitting worksheet 1030. Information from the income splitting worksheet is recorded or transferred to the tax strategy worksheet 1040. The income splitting worksheet may be in paper or electronic form and may be incorporated as part of the tax strategy worksheet. When the client enters information in electronic form such as entering answers in response to prompts generated on a computer display, the information entered by the client is indexed for future processing as described further below. It is also worth noting that the income may also be moved or split to a lower taxable entity such as a C corporation.

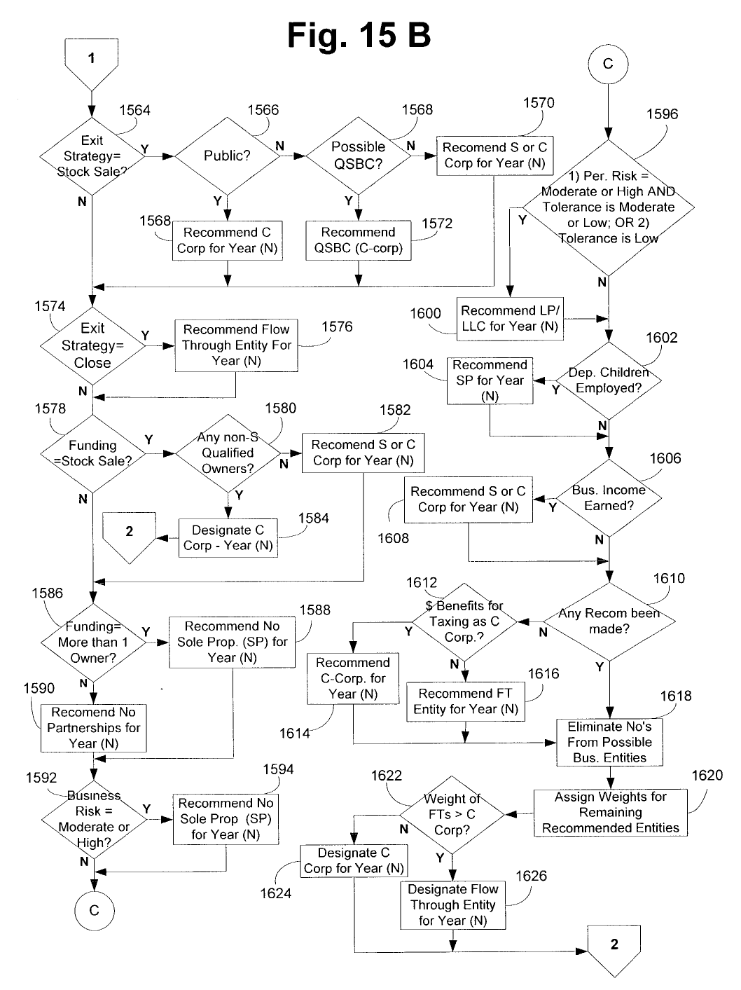

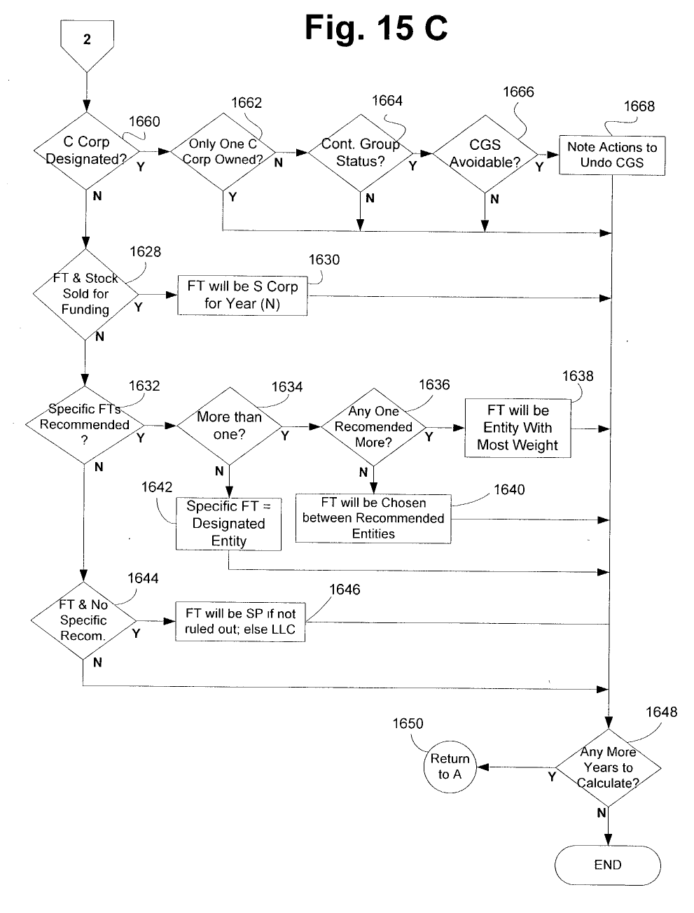

Using the items of information recorded on the worksheet for preparing the tax strategy, a marginal tax rate can be determined for the client's business and a marginal tax rate of the client may be determined 630. The marginal rate is the top rate of the graduated tax rates and is based on personal income of the client. The personal income of the client may or may not include the income from any owned businesses, depending on whether the businesses are flow through entities. The client's marginal tax rate is preferably determined with and without inclusion of flow through business income and is based on current year IRS tax tables. The client's marginal rate inclusive of business income and marginal rate exclusive of business income are both recorded on the worksheet for preparing the tax strategy. These marginal tax rates are based on the client's current business structures (e.g., before implementing new business and investment structures) and may be used for comparison with marginal rates computed for different hypothetical business structures in order to select an appropriate business structure as described below with reference to FIGS. 15A-15C.

Another factor to consider in determining recommended business and investment structures is the intentions of the client for eventually closing, selling or otherwise transferring ownership of businesses or business assets, hereinafter referred to as an “exit strategy.” There may be significant income tax consequences that arise when a business or its assets are sold, closed or otherwise transferred. Moreover, some business structures require significant resources to close. For example, a C corporation is not easily dissolved and thus if the client intends to close the business at some point this may not be a business structure worth pursuing. The tax considerations involved in various exit strategies may vary immensely between different types of business structures and thus a client may wish to determine an appropriate business structure and/or a preferred exit strategy based on tax consequences. For these reasons, it is beneficial in preparing a tax strategy to take into account considerations involved in a client's exit strategy.

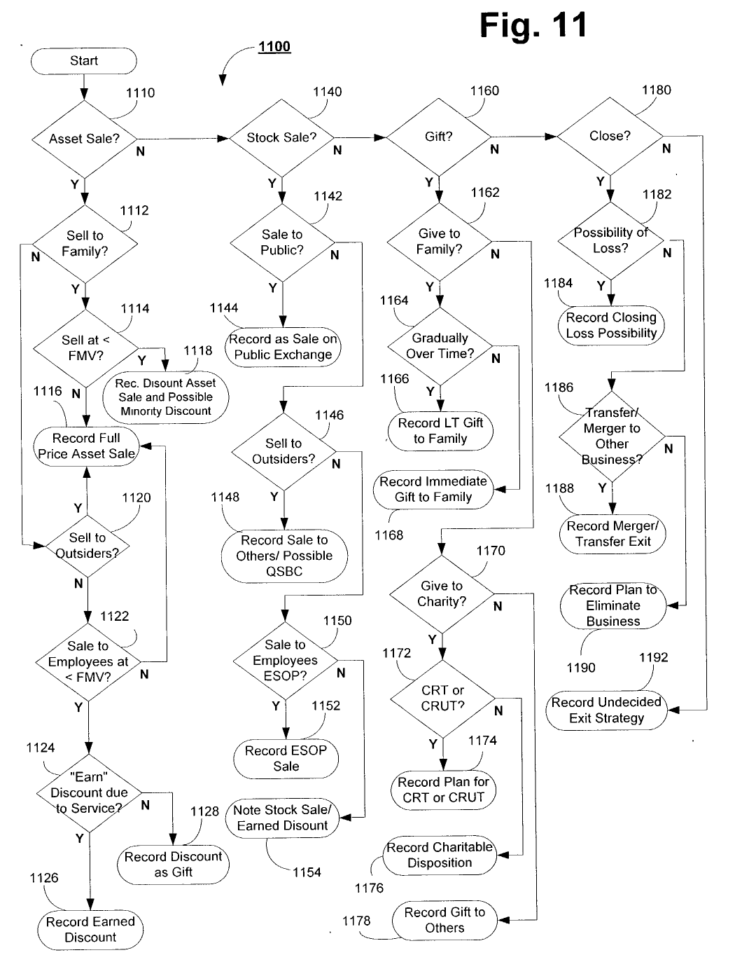

A method of determining an exit strategy 1100 is illustrated in the flow chart of FIG. 11. Essentially, there are several ways in which a business owner may exit a business, including: (i) the sale of business assets 1110; (ii) the sale or gifting of business stock 1140; (iii) gifting the business 1160; and (iv) closing the business 1180, which can include going out of business entirely or merging into another business. It is also possible that a business owner is not ready to decide how to exit a business venture 1192.

Within each of the foregoing categories, there are several possibilities that may affect a client's tax burden. For selling assets of a company including its “book of business,” a determination should be made whether the sale will be made to family 1112, outsiders 1120 or to employees 1122. It the client intends to sell a business or businesses to his or her family, it is determined whether the sale will be at fair market value (FMV) or a discounted asset sale 1114. If the company assets will be sold at fair market value to either family members (in an arm's length transaction) or outsiders, the client will pay at the ordinary tax rate for recaptured depreciation and at the capital gains tax rate for the remainder of gain on the proceeds from the sale and full price asset sale is recorded as the exit strategy on the tax strategy worksheet 1116. However, if the client's intentions are to sell the business to his family at a discounted price, (i.e., below fair market value) a discounted asset sale is recorded as the exit strategy on the tax strategy worksheet 1118. Eligibility for minority discounts should be considered for the discounted sale of assets. For example, when a party holds a minority ownership (less than 50%) with little control over the business entity, the value of the interest can be discounted by up to 30-50%. In other words, if the total value of assets held is $1,000,000 and a party owns 20%, the value of the ownership might be only $140,000 instead of the mathematically correct $200,000. If the company assets will be sold to employees, it is determined whether the assets will be sold at or below fair market value 1122. If the assets are sold at or above fair market value, a full price asset sale is recorded as the exit strategy 1116. However, if the sale of assets to employees is below fair market value, it is determined whether the discounted price, or a portion thereof, is or will be “earned” due to services performed by the employees 1124. The consequences of “earned” discounts include the ability of the business owner to reduce the business income by the amount of the “earned” portion of the discount. If the discounted price will result from services performed by employees, it is recorded as an earned discount sale of assets on the tax strategy worksheet 1126. If the discount on the sale of assets to employees is not earned, or will not be earned, the discounted portion of the asset sale is recorded as a gift to the employees on the tax strategy worksheet 1128.

If the client's exit strategy includes selling ownership of stock in the business 1140, as with the sale of assets, it is beneficial to determine who will be buying the stock. If the stock will be sold to the public 1142 through a stock exchange, for example, the NASDAQ, NYSE, CPC, then it is recorded as a public stock sale 1144 on the tax strategy worksheet. The sale of stock through a public exchange will eventually require that the client's business be a C corporation business entity.

The consequences of selling the stock may include paying capital gains tax on the proceeds of the stock sale. Capital gains rates vary depending on whether it is consider a short-term or long-term gain. A short-term gain is a proceed on stock that has been held for less than a year, which is not likely in the case of exiting a business. The short-term gains are typically added to the seller's income and taxed at income rates. On the other hand, a long-term gain is a gain realized on stock held for longer than one year. Long-term gains are typically taxed at a rate of 20% if the client has a marginal income tax rate greater than 15%.

If the company stock will be sold to non-public outsiders 1146 such as another company, this is recorded in the worksheet 1148. In this case, a considerable tax benefit may be applicable if the client business can qualify as a qualified small business corporation (QSBC). A QSBC is a special type of C Corporation that enjoys a significant capital gains exemption upon the selling of the business stock. To qualify as a QSBC, certain tests must be met: the non-corporate stockholder must hold the property for five or more years and to qualify as a QSBC, stock must have been issued after Aug. 10, 1993 and at no time have the gross aggregate assets exceeded $50 million. Alternatively, the client may wish to sell the stock to employees of the business. There are two principle options involved in selling stock to employees. One option is to allow employees the benefit of purchasing stocks at a reduced rate during the operation of the business. This option may provide significant tax benefits and is commonly referred to as an employee stock option plan (ESOP). Use of an ESOP plan, may allow the employee to defer tax on the value of the stock and later take that gain under the lower capital gains tax rate. There are several important formalities to enable a company to receive tax benefits from an ESOP, most notably, it requires a company to have a qualifying documented plan. If the client desires this option, it is recorded as the exit strategy on the tax strategy worksheet 1152. The second option is to sell the stock to the employees at full price. The tax consequences of this option are the same as selling the stock at full price to the public 1142 or others 1148 and the stock sale is recorded on the worksheet 1154.

Another potential exit strategy is giving the business as a gift 1160 to family members 1162, charities 1170 and/or others entities 1178. When gifting the business to family members 1162 different tax consequences arise depending on the manner in which the business if given. Gifts of significant value may result in dire tax penalties. Gift and estate tax rates can exceed 50% of the value of the gift depending on the value of the transferred wealth.

If the business is given to family members over a long period of time 1164, the owner may take advantage of certain benefits. For example, the owner may benefit from the Gift Tax exclusion that allows an individual to give a $10,000 per year gift to another without incurring any gift taxes. The owner may also take advantage of a minority ownership discount. Essentially, a minority ownership discount enables the transfer of stock to family members at a discounted price (i.e., lower than the face value of the stock) if the transfer is less than a majority interest of the business. The discounted percentage is tax free if the transfer qualifies as a minority discount. If the business will be gifted to the family over a long term, this is noted as the exit strategy in the tax strategy worksheet 1166, otherwise it is recorded as an immediate gift to family 1168.

Current U.S. tax laws also allow tax-free gifting to qualified charities. The IRS defines what a qualified charity is and thus it is not discussed here. However, if the client desires to donate personal or business assets to charity 1170, it is determined whether the client may wish to set up a Charitable Remainder Trust (CRT) for the charity or just give the business away later 1172. A CRT is a way to realize a tax deduction today while providing for retirement income in later years and providing estate planning benefits. CRTs allow a donor to transfer property to a charity, while retaining the right to the income generated by that property during the donor/donor's spouse lifetime (or for some other period of time) and then allowing the eventual transfer of the property's ownership to the charity.

Benefits for CRTs include receiving an income tax deduction at the time the trust is created, thus avoiding capital gains and gift taxes while maintaining an annual income for the donor. The CRT is a good tool for disposal of highly appreciated assets. While the assets will eventually revert to the charity rather than heirs of the estate, the use of proceeds from the CRT to pay for an irrevocable life insurance trust could replace the asset's value for the heirs. The most common types of CRTs include the charitable remainder unit trust (CRUT), the charity remainder annuity trust (CRAT) and the flip unitrust (FLIP). There are very complicated rules to establishing a qualifying CRT that are well known to estate planners and tax professionals and thus are not discussed here in detail. However, the decision to exit the business using a CRT is recorded in the tax strategy worksheet 1174 for later consideration in implementing the developed tax strategy.

It should be recognized that because of the frequency of changes in tax laws, the specific embodiments described above with respect to determining an exit strategy would vary. The skilled tax practitioner will realize that the benefits and disadvantages of exit strategies significantly depend on these changes in tax law. Accordingly, the methods and systems of the present invention are not intended to be limited to any particular tax laws but rather adapted to the tax laws of a particular jurisdiction and modified as the tax laws change. For example, if the IRS eliminates the advantages of CRTs, they may no longer be considered as an option with respect to the gifting portion of a client's exit strategy.

Another important consideration in determining a tax strategy is the source(s) of funding for the client's businesses. For example, if a client wishes to create a publicly traded company for funding, the choice of entity must be a C Corporation. On the other hand, if the client is looking for partners to share in gain, but with no voting or management control, a limited partnership or form of Limited Liability Company may be desirable. The funding sources may assist in determining appropriate business structures for the client's tax strategy and tax accounting for business funds. A preferred method of determining funding sources 1200 is illustrated by the flow diagram of FIG. 12. The first question the client determines is whether funding will be needed for a business 1205. If not, “no funding considerations” is recorded in the tax strategy worksheet 1210. If so, the client determines where the funding will originate. In this determination there are essentially two choices: (1) the business owner will provide 100% of the financing; or (2) others will provide at least some of the financing. If funding will come from entities that will have no ownership in the business 1240 then there are “no funding considerations” is recorded 1210.

Option (1) includes loans obtained by the business owner such as personal and business loans. Business loans in some cases may require personal guarantees by the owner, or the business could be sufficiently capitalized with history of income that would allow the owner to not pledge other assets. Option (2) includes investors, partners and financiers, including businesses entities already owned by the client. If the business owner/client will be providing funding 1220, through, for example, a bank loan, the percentage of client funding and accounting for the funding is determined and recorded 1225 (e.g., note, capital, contributed assets). When cash or assets are contributed to a company, a choice must be made to determine whether the value will increase the owner's basis in the company (through increased capital account or stock ownership) or will increase a note payable to the owner. In the case of the note, interest will accrue and at some point, the interest and the principal portion of the note will be repaid to the owner.

If at least part of the funding for the client business will come from a third party which will have ownership, other than a bank loan 1240 then it is determined whether the funds will be obtained from public investors (i.e., publicly traded) 1235. If the funding will come from public investors, then the company is recorded as a C Corporation 1240. The rights and percentage of ownership for all owners is determined and recorded 1245, 1250 and 1260. The recorded funding and ownership information is helpful in determining appropriate businesses and investment structures for the client.

Yet another important factor in considering appropriate business structures is determining potential risks for the type of business the client owns and determining the client's tolerance risks. The legal and financial risks of owning and operating a business may be significant depending on the type of business. Each business may be liable for damages resulting from its business operations, including worker negligence, physical hazards caused business operations, employee discrimination or medical suits, and general risks involved in financing the business. These liabilities, in some instances, can overflow to the personal assets of business owners and investors. Moreover, business assets may be subject to the personal liabilities of business owners depending on the type of business structure. Consequently, it is important for business owners to realize that certain types of business structures and combinations thereof may be used to protect the personal assets of business owners from the risks of operating the business as well as protect business assets from the personal liabilities of business owners. Due the to varying degrees of protection for each type of business structure as well as their associated tax consequences, the tolerance of the business owner for risk should also be taken into consideration.

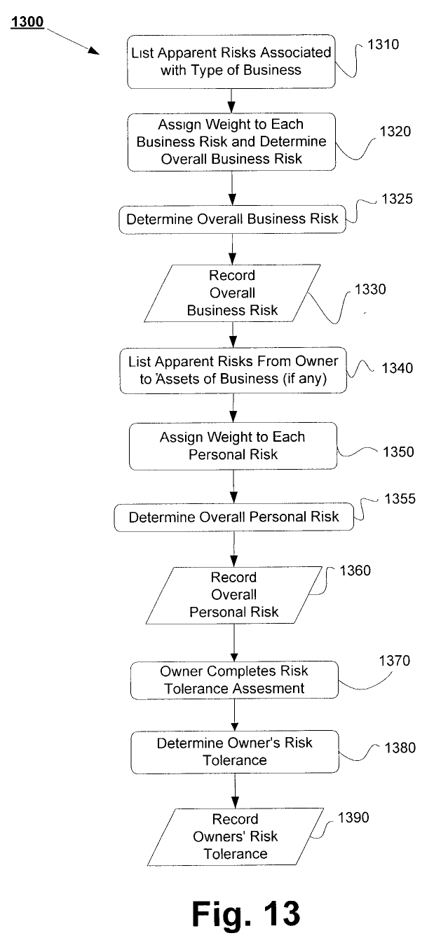

Referring to FIG. 13, a preferred method for factoring risks 1300 in an accelerated tax reduction method and system includes: (i) determining the overall risks involved in owning/operating a business; (ii) determining potential personal liabilities of a business owner; and (iii) determining the business owner's tolerance for risk.

As with all the processes described herein, this method uses information obtained from the client, for example, by the client: providing information in response to computer prompts, filling out a worksheet or questionnaire, and/or providing information in response to questions presented by a tax strategist. Preferably, the evaluation of risk factors for developing a tax strategy includes considering the overall potential risks to personal assets involved in the type of business owned by the client (“business risks”), considering the overall potential risks to the business assets from the client's personal circumstances (“personal risks”), and the client's tolerance of these risks (“risk tolerance”).

Although the method of factoring risks may be performed in any order, method 1300 shown in FIG. 13 begins with the client listing apparent risks associated with the type of business owned 1310. This step may involve the client or other knowledgeable entity listing every specific type of risk imaginable from operation of the business. For example, a construction business may encounter the following specific business risks: suits from customers for damages resulting from construction operations, including the negligence or intentional torts of its employees; financial risks from overextending on construction projects; breeches of warranty, etc.

Once the business risks are listed, a weight is assigned for each risk 1320. In the preferred embodiment, the client assigns the weight since the client is most familiar with that type of business. However, the tax strategist, computer or other entity may assign weights for each specific business risk. The assignment of weight to individual business risks may take into consideration insurance and other types of liability protection, for example bonds and policies currently in place to offset these business risks. Weight assignment may be performed in any manner; for example, the client may select a number between “1” and “10” with “10” being the greatest risk, “5” being a moderate risk and “1” being the lowest risk or a remote risk. Once each specific business risk is assigned a weight, the overall business risk may be determined 1325 by a person or computer. One way to make this determination may involve for example, averaging the specific risks by adding the individual weight assignments and dividing the summed total by the number of specific risks listed. The resultant average may sufficiently indicate whether the client's business involves a high, moderate or low business risk. The overall business risk should be recorded in the tax strategy worksheet 1330.

Next, if any are apparent, the client or other knowledgeable entity lists any specific personal risks they have that may affect business assets 1340. By way of example, personal risks may include, teenage children with a propensity or possibility to drink and drive, business owner's dangerous personal endeavors such as piloting an airplane and even other business endeavors the client may be involved in (particularly sole proprietorships) may be considered, e.g., owning a bar. If any personal risks are listed, they are assigned weight 1350 to determine an overall personal risk 1355 in a manner similar to that previously discussed. The overall personal risk is recorded on the tax strategy worksheet 1360.

In order to determine appropriate business and investment structures for the client, the tolerance of the client to encounter risks should be determined. The client's risk tolerance may be determined in any manner, for example, asking the client whether they are concerned about the previously determined risks. Conversely, it may be preferable to quantify the risk tolerance of the client since the client may not be aware of his or her own tolerance and/or since a quantifiable number is beneficial for computer implementation of the invention. Quantifying risk tolerance may be performed in various manners but preferably, the client is given a risk tolerance quiz 1370 and the score of the quiz determines the client's risk tolerance 1380. Once the client's risk tolerance is determined, it may be recorded on the tax strategy worksheet.

The risk tolerance quiz involves the client answering questions that assess the client's tolerance for risk. The following is an example risk tolerance quiz:

### EXAMPLE 2

(1) I would feel comfortable risking _____ % of my investable money if the chance of doubling it was _____ %:

(a) 0% and 0%;

(b) 10% and 10%;

(c) 25% and 25%; or

(e) 50% and 50%.

(2) What do you want your money to do for you?

(a) Grow as fast as possible; current income is not important;

(b) Grow faster than inflation; produce some income;

(c) Grow slowly and provide a nice income; or

(d) Preserve principal, no matter what.

(3) You have just heard that the stock market fell by 10% today; your reaction is:

(a) Consider reducing the proportion of your portfolio that is invested in equities;

(b) Be concerned and continue to monitor the market; or

(c) Not to worry because the market is likely to go up again some time in the future.

(4) Which of the following best describes how you evaluate the performance of your investments?

(a) My greatest concern is this quarter's performance;

(b) The past 12 months are the most important to me; or

(c) I look at the performance over several years to help form an opinion about an investment's attractiveness.

(5) What is the worst one-year performance you would tolerate for your portfolio?

(a) −12%;

(b) −8%;

(c) −4%; or

(d) any loss is unacceptable to me.

Choose the response that most accurately reflects your feelings or behavior:

(6) I generally prefer to stay in a familiar situation, rather than take a chance on a new situation.

(a) Yes, exactly like me;

(b) Somewhat like me;

(c) Not very much like me; or

(d) Not at all like me.

(7) I am usually the one who “gives in” when my plans conflict with the plans of those around me.

(a) Yes, exactly like me;

(b) Somewhat like me;

(c) Not very much like me; or

(d) Not at all like me.

(8) I often put off making financial decisions because I am afraid of making a mistake.

(a) Yes, exactly like me;

(b) Somewhat like me;

(c) Not very much like me; or

(d) Not at all like me.

(9) I am optimistic about what the future hold for the economy.

(a) Yes, exactly like me;

(b) Somewhat like me;

(c) Not very much like me; or

(d) Not at all like me.

(10) My lack of knowledge about investments keeps me from becoming more involved in financial planning activities.

(a) Yes, exactly like me;

(b) Somewhat like me;

(c) Not very much like me; or

(d) Not at all like me.

(11) I often feel that I don't have enough control over the direction my life is taking.

(a) Yes, exactly like me;

(b) Somewhat like me;

(c) Not very much like me; or

(d) Not at all like me.

(12) I would feel very embarrassed if any found out I made a major investment mistake.

(a) Yes, exactly like me;

(b) Somewhat like me;

(c) Not very much like me; or

(d) Not at all like me.

To score the answers to the foregoing quiz, each of questions 1, 3-4, 6-8, and 10-12, is scored as follows: a “1” is given for answer “a,” a “2” is given for answer “b,” a “3” is given for answer “c” and a “4” is given for answer “d.” For each of questions 2, 5 and 9 the scoring is: a “1” for every “d,” a “2” for every “c,” a “3” for every “b” and a “4” for every “a.”

Assessment of the scores to the risk tolerance quiz is as follows:

[Score=12-21] You have a lower risk tolerance. Many time this is due to circumstances you might not be aware of that are impacting you. Continue to get more information to correctly understand where real and imaginary risk occurs. Look for ways to reduce risk and contain the part that makes you uncomfortable.

[Score=22-311] You have a moderate risk tolerance. You can tolerate risk when you have a reasonable expectation that you will receive gain from taking the risk. Carefully assess possible gain and weigh it against the loss you might experience. There is a range within the “moderate” title- you may be more comfortable with risk than the average person, but you will likely be the person to always want information before you act.

[Score=32-40] You have a high tolerance for risk. Not only do you not mind taking risk, you get bored if you don't have a certain risk factor in everything you do. You are happiest when there is a potential for “all or nothing.” You will be able to handle risk in your financial life, but make sure you have done adequate homework to support the decisions and aren't fool heartedly jumping into something just because it sounds exciting.

The foregoing assessment of the client's risk tolerance may be recorded 1390 as a number or description. For example, a high risk tolerance may be designated as a “1,” a moderate risk tolerance as a “2” and a low risk tolerance a “3.”

Using all of the information recorded on the tax strategy worksheet, the tax strategist (including computer) may evaluate the client's present business and investment structures, and propose new business and investment structures to be implemented 650 (FIG. 6). In order to accomplish this task, it is important to understand the basic types of business and investment structures available in the jurisdiction of the business. While the types of available structures and their associated details, including benefits and disadvantages, vary and are subject to frequent change, the following is a basic description of the choices available in the U.S.:

Essentially, there are three basic categories of business structures in the United States: (1) the sole proprietorship; (2) corporations (S and C corporations); and (3) partnerships and limited liability companies (LLC). Selecting the most appropriate structure for an organization is not an exact science and combining the different types of structures for a client's multiple businesses to provide maximum benefits, is complicated. A basic concept of each type of business structure is whether the income earned by the business passes or “flows-through” to the owners. A flow-through business structure is essentially any business structure other than a C corporation (it is worthy of noting that some partnerships may be taxed as a C corporation). The following brief description of each type of business structure is helpful for choosing appropriate business structures.

Sole proprietorship. As implied by its name, this type of business structure may only be used for businesses having only one owner. Historically, the sole proprietorship (SP) has been attributed poor tax consequences and thus largely ignored as a preferred business structure. However, due to many recent changes in tax regulations, the SP has become a more promising venture. SPs are good candidates for initial business ventures since the SP is cost effective and easily changed to a different type of structure should another become more desirable. Additionally, the SP is easy to dissolve, which takes into account the exit strategy of the client. In regard to tax consequences SPs may soon be able to deduct health insurance costs of employees and owners. Sole proprietorship summary: simple and inexpensive to create and operate; few tax benefits; and owner is personally liable for business debts.

Corporations. Corporations commonly used by businesses today include C corporations, S corporations and professional corporations (PC). Corporations provide a good liability shelter for the personal assets of corporate owners. C corporations provide many unique tax advantages that are not available for most other types of business structures including S corporations, some of which have been discussed previously with respect to the Benefit Deduction System of FIG. 9. Additionally, the tax rates for the C corporations taxable income may be lower than those of individuals depending on the taxable amount of income.

One of the biggest advantages for C corporations is the ability to apply corporate profits to reinvestment without owners incurring personal taxation of these undistributed reinvestment profits. Other advantages of C corporations include the ability to set their taxable year (e.g., the C corporation can pay taxes on a different calendar than individuals). This can prove to be an important advantage when a C corporation is a parent to, for example an LLC. Since the profits from the LLC become taxable income for the C corporation, the taxes may be calculated at the corporate rate and may be deferred to the end of the C corporations taxable year. Additionally, corporate business structures are not subject to the self-employment tax which owners of partnerships, LLCs and SPs incur. On the other hand C corporations can be expensive to create and difficult to dissolve and thus it may not be a preferred option for a business requiring flexibility. Additionally, income generated by C corporations is generally taxed once at the corporate level and then again at a personal level when dividends are distributed to owners. The rules and formal requirements for C corporations may also be difficult to deal with for inexperienced and small business owners.

C corporation Summary: Owners have limited personal liability for business debts; fringe benefits can be deducted as business expenses; owners can split corporate profits among owners and corporation, paying lower overall tax rate; more expensive to create than SPs or partnerships; paperwork formalities are burdensome; and treated as separate taxable entity than owners.

S corporations have more flexibility than C corporations but still have rigorous requirements including a limit on the number and type of shareholders that can own S corporation stock. A unique benefit of the S corporation is that it can be the parent of a qualified subchapter S subsidiary (QSSS). The QSSS is an S corporation that, when elected, can have all income/losses and deductions of the QSSS attributed to its parent as if the S corporation parent incurred them. S corporations summary: owners have limited personal liability for business debts; owners report their share of corporate profit or loss on their personal tax returns; owners can use corporate loss to offset income from other sources; more expensive to create than partnership or SP; more paperwork than for a LLC, which offers similar advantages; Income must be allocated to owners according to their ownership interest; and deductible fringe benefits limited to owners who own more than 2% of shares.

Partnerships and LLCs. Partnerships may vary between general partnerships, limited partnerships (LPs) and limited liability partnerships (LLPs). The limited liability company (LLC) and professional limited liability company (PLLC) are relatively new structures not available in all jurisdictions. For tax purposes, Partnerships and LLCs are more similar to SPs and S corporations rather than C corporations in that, income for these types of business structures is taxed as income at the owners marginal rate whereas C corporations are taxed as separate entities. Partnerships and LLCs are often referred to as conduit entities since their income and losses pass through to their owners. The character of the conduit entities income (e.g., capital income) remains the same when passed through to owners. This can be advantageous in certain cases. For example, the maximum rate on net capital gains is 20% when an individual has a higher marginal tax rate. If the individual's business produces large capital gains, a partnership may be beneficial so that gains from the business are not taxed at the individual's marginal rate, but rather at the maximum capital gains rate. This advantage is not afforded C corporations. The following is a brief summary for each of the available business structures under this category:

General partnership summary (GP): simple and inexpensive to create and operate; owners (partners) report their share of profit or loss on their personal tax returns; and owners may be personally liable for business debts.

Limited partnership (LP) summary: two type of owners, general partners and limited partners; limited partners have limited personal liability for business debts if they do not participate in management; general partners may raise funds without involving outside investors in management of business; general partners may be personally liable for business debts; more expensive to create than general partnership; and preferable for companies investing in real estate or other appreciating assets.

Limited liability partnership (LLP) summary: used primarily for professional services such as accounting law and medicine; partners (owners) are not personally liable for other partners negligence or malpractice; shares of profits reported on personal income tax returns of partners; not available in every state; partners may be personally liable for certain business obligations unlike LLCs.

Limited liability company (LLC) summary: owners (members) have limited personal liability for business debts even though they may participate in management; profits and losses may be split between members on a basis other than percentage of membership interest; more expensive to create than a partnership or SP; particularly useful in foreign ventures since they are widely recognized by foreign countries; may be taxed as a partnership or a corporation depending on election by owners; some states require more than one member.

Professional limited liability company (PLLC) summary: same as an LLC but owners must all belong to same profession; used primarily for legal professions.

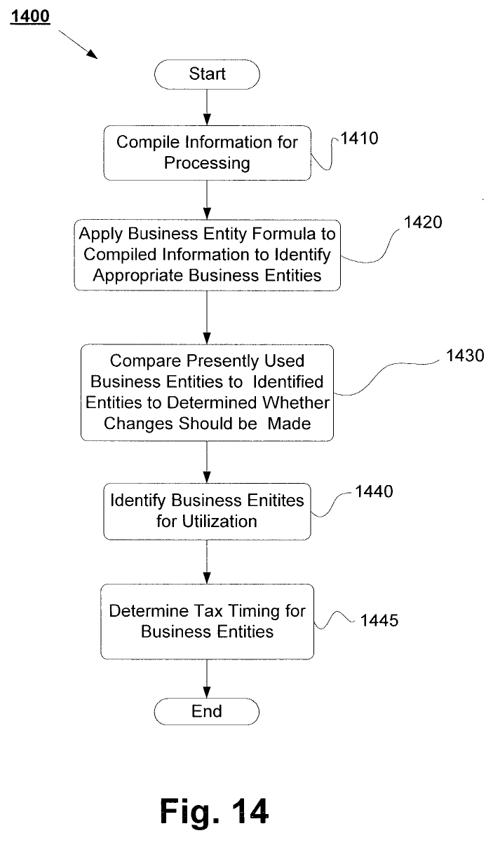

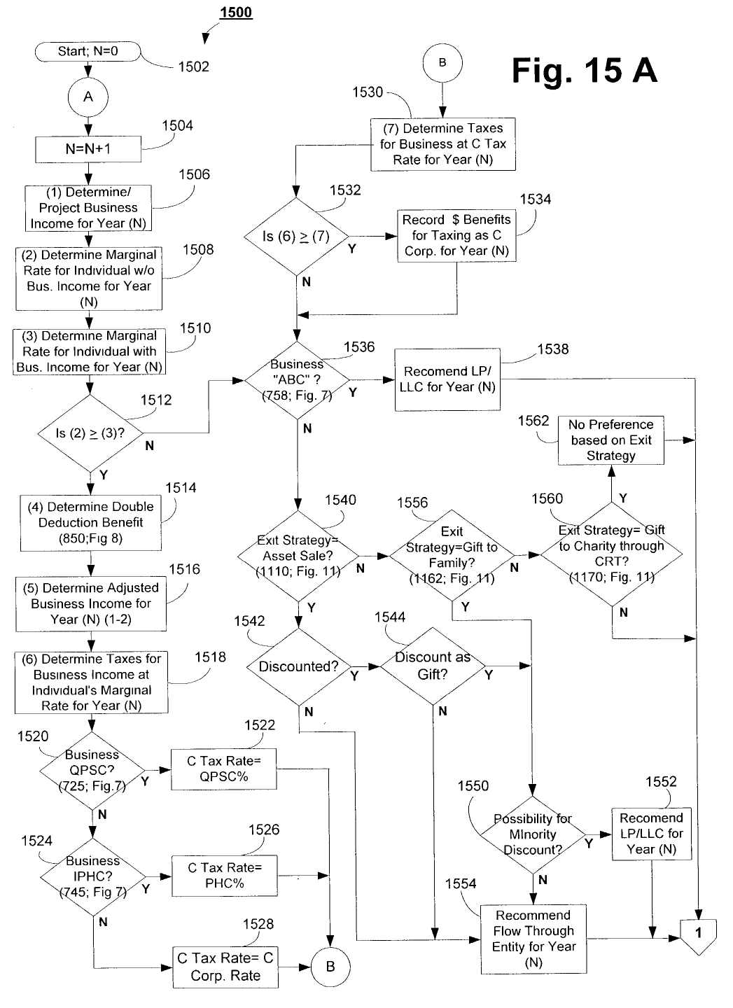

In an effort to determine the best possible business and investment structures (collectively referred to herein as “business entities”), or combination of business entities for a client, some or all of the information resulting from the previously discussed processes is considered. As shown in FIG. 14, a preferred method for evaluating and selecting business entities 1400 includes: (i) compiling client information for processing 1410; (ii) applying an algorithm to the collected information to determine recommended business entities 1420; (iii) comparing the client's present business entities with the recommended business entities to determine whether the client's present business entities should be changed 1430; and (iv) identifying business entities for the client to utilize 1440. Additionally, depending on the type of structure of the identified business entities for utilization, the additional step of (v) determining tax timing for the business entities 1445 may be performed. As with the majority of the method(s) steps described herein, this may be performed manually or with the aid of an automated system, e.g., a computer running a software program.

Compiling the client's information for processing 1410 includes retrieving or gathering the information previously recorded on the tax strategy worksheet from processes 605-645. The compilation of this information may be performed in any manner, for example, when the information is in electronic form (e.g., binary or hexadecimal data), the data may be retrieved from a memory (e.g., disk or device) and/or loaded into a random access memory (RAM) accessible by a computer processing unit (CPU). Compilation or gathering of the information by a person (e.g., tax advisor) may include reviewing the document or documents on which the information was previously recorded.

The compiled or gathered information may then be evaluated using a formula for selecting business entities to determine the business entities that are most suitable for the client's business and circumstances 1420. The process or algorithm for selecting suitable business entities is configured based on the current tax and liability laws for different types of business entities available. Consequently, while an example process for selecting business entities is disclosed below, the invention is not limited to any specific formula or organization since available business entities and their associated tax and liability consequences vary from time to time and between jurisdictions.

In one embodiment of the invention, the business entity selection formula uses a method for selecting business entities that (i) evaluates the data of the previously described processes 605-645 (FIG. 6), (ii) associates a most appropriate business entity for each specific process 605-645, (iii) assigns a weight for each specific process 605-645 and the associated business entity; and determines one or more recommend business entities by evaluating which business entities have the greatest sum of assigned weights.

A preferred method for selecting business entities is shown in FIGS. 15A-15C and includes setting an incremental counter N to zero 1502 at the beginning of method 1500. At step 1504, the counter N is incremented 1504 to reflect a year for which the business entity formula is determining business entities. A first determination in method 1500 is to determine whether business income from a client's business increase the marginal rate of the client. This step involves: (1) determining or projecting the gross business income for year (N) 1506, (2) determining the marginal tax rates for the client with and without the business income 1510, 1508; and (3) comparing the marginal rates to determine whether the business income increases the marginal rate of the client 1512. If the business income does not increase the client's marginal rate 1512, there is no need to evaluate the advantages of the C corporation tax rates and steps 1515-1534 may be skipped. Otherwise, a determination of whether any benefits will be obtained by taxing the business as a C Corporation.

In order to effectively determine the benefits of being taxed as a C corporation, several factors must be taken into consideration. The adjusted business income is determined 1516 by subtracting the deductible benefits (1514) identified by the Benefit Deduction System (DDS) (FIG. 8) from the gross business income 1506 for year (N). It should be noted that while most of the available deductions from the DDS are for C corporations, some are available for other types of business entities. Consequently, the adjusted business income may be determined for (1) a C corporation and (2) other types of business entities (referred to herein as “flow through entities”). Next, the taxes for the business income are determined at the client's marginal tax rate (from 1510) 1518 as it would be taxed via a flow through entity. Then, the taxes are determined for the business income (adjusted business income) at a C corporation rate 1530.

The tax rate for a C corporation may depend on whether the corporation is a QPSC (725; FIG. 7) or an IPHC (745; FIG. 7). If the company is a QPSC 1520 the QPSC % specified in the IRS code is the rate at which the adjusted business income will be taxed 1522. If the company is an IPHC 1524, the PHC % specified in the IRS code is the rate at which the adjusted business income will be taxed 1526. Alternatively, if the company is neither, or can avoid being a QPSC and/or PHC, the standard C corporation tax rates, as defined by the current tax code, are applied to the adjusted business income 1528. Using the appropriate tax rate, the taxes for the business income are determined for year (N) 1530 and compared with the taxes on business income at the client's marginal rate 1532. If there are any C corporation tax benefits, the benefits are recorded for later evaluation 1534.

If the company is characterized as an asset building company or “ABC” 1536 (FIG. 7; 758), a limited partnership (LP) or Limited Liability Company (LLC) is recommended as the business entity of choice. This is due, in part, to the following reasons: (1) the ease by which one can perform a Section 1031 (like-kind) exchange; (2) the ability to distribute assets to owners; and (3) capital gains tax treatment. A recommendation, as used in the business entity selection method 1500, means an initial identification of preference toward a particular business entity or entities, as opposed to a final determination or designation. If the company is not an “ABC,” the information from the client's exit strategy (FIG. 11) is evaluated for sale of assets 1540, gifts to family 1556, gifts to charity through a CRT 1560; stock sale 1564 and closing the business 1574.

If the client's exit strategy involves the sale of company assets 1540, it is determined whether there will be a discounted sale 1542, whether any discount will be earned or classified as a gift 1544, and whether a minority discount is applicable 1550. If the exit strategy involves the full price sale of assets, a flow through entity is recommended as the business entity of choice for year (N) 1554. This is because of the possibility of double taxation from liquidating dividends in a C corporation. However, if other factors strongly recommend a C corporation, a long-term exit strategy may be determined to allow for the business to remain in place and not liquidate. Such a strategy would include setting up others, including a board of directors, to handle management and operation decisions to board. It could also be indicated that an employee ownership plan is desirable to have employee's more involved in the management and direction of the company.

If the exit strategy involves an earned discounted asset sale 1548, a flow through entity is also the recommended business entity of choice for year (N) 1554. The reduction of income for providing the earned discount should be noted to properly calculate business income tax for future years. If the exit strategy involves a discounted asset sale due to a gift, it is determined whether a minority discount can apply to the discounted gift of assets 1550. If a minority discount can apply, a LP/LLC is recommended for the business entity 1552. If a minority discount does not apply, any flow through entity is recommended.

In a similar fashion, if the exit strategy involves a gift to family members 1556, the possibility of minority discounts should be evaluated 1550. If a minority discount program is applicable, the recommended business entity is an LP or LLC. Otherwise, any flow through (FT) entity is recommended.

If the exit strategy is a gift to charity through a CRT 1560, there will not be a preference to business structure type resulting from the exit strategy 1562. If the exit strategy involves the sale of stock 1564 to the public 1566, a C corporation is recommended 1568. If other factors do not favor a C corporation, a long-term strategy to eventually convert the company to a C corporation should be considered. If the company stock will be sold to private investors it is evaluated whether the company can meet the definition of a qualified small business corporation QBSC 1568. A qualified small business corporation is a C corporation with gross assets less than or equal to fifty million dollars where corporate stock is held for more than five years. The benefit of a QBSC is that one half of most gains is excluded from gross income. While the includable half is taxed at 28% instead of the 20% corporate rate, stockholders may defer recognition of 100% of the gain if the proceeds are reinvested in other QSBC stock. If the company can be a QSBC, it is strongly recommended for the business entity of choice 1572 where the exit strategy includes the sale of stock. If the company cannot be a QSBC then the recommended business entity is either an S corporation or a C corporation for year (N) 1570.

Lastly, if the exit strategy is to close the business 1574, a flow through entity is recommended for year (N) 1576 since C corporations are not easily dissolved and to avoid possible double taxation of liquidating dividends. Although not shown, if the client is undecided on an exit strategy, the consequences of long-term holding may lead to a C corporation recommendation for ease of running the business.

Next, the method of selecting business entities 1500 takes into consideration the funding sources for the business (FIG. 12). If funding for the business will be at least partially through the sale of stock 1578 it is determined whether any stock owners will disqualify the business from being an S corporation 1580. For example, currently, if there will be more than 80 shareholders or any shareholder is a non-U.S. resident, the business cannot be an S corporation. Consequently, this determination causes the business entity to be designated as a C corporation. Rather than a recommendation, this designation is definite since the sale of stock requires a corporation and if it cannot qualify as an S corporation, then it must be a C corporation (therefore the method continues from this point on to FIG. l5C). In the alternative, if the ownership of stock could possibly qualify as an S corporation, then either an S or C corporation is recommended and one may be selected over the other based on other factors in the process or based on client preference.

If the funding considerations indicate there is more than one owner of the business 1586, then the recommendation indicates the business entity “not be” a sole proprietorship (SP) l588. Likewise, if the funding considerations, or other client provided information, indicate there is only one owner, then the recommendation indicates the business entity “not be” a partnership 1590.

Next, the method of selecting business entities 1500 considers the personal/business risks involved and the client's tolerance of risk (FIG. 13). If the business risk is moderate or high 1592, “no” sole proprietorship is the recommendation for year (N) 1594. This is because SP owners are personally liable for business related risks. If the personal risk of the client is moderate or high and the client's risk tolerance is moderate or low 1596 a LP or LLC is recommended as the business entity of choice 1600. The LP or LLC is always recommended when the client's risk tolerance is low because in corporate structures, corporate interests are subject to the personal liabilities of their owners.

Additional miscellaneous factors may also be considered in the method of selecting business entities 1500. These miscellaneous factors may include determining whether dependent children will be employed 1602 and whether the business income will be “earned” income 1606. If dependent minor children will be employed, the recommendation leans toward a sole proprietorship 1604 since a payroll tax for the employed dependents is not required under a schedule C entity. If the business income is “earned” income, the recommendation is for an S or C Corporation 1608 to avoid the self-employment tax on other types of business entities.

The next step in the preferred method is to determine whether any recommendations have been made 1610. If no recommendations have thus far been made, it is determined whether there were any benefits for taxing the business income as a C Corporation (1534) 1612. If there are any advantages to taxation as a C Corporation, the C Corporation is recommended 1614. On the other hand, if no benefits are apparent, the recommendation is for a flow through entity 1616. Next the process continues by eliminating the negative recommendations from the possible selection of business entities 1618. The negative recommendations are those such as recommend the business entity “not be” sole proprietorship. Each of the remaining business entities is assigned a weight 1620 in order to determine the overall best entity. The assignment of weight may be performed in any conventional manner such as awarding a value for each time a type of business entity was recommended, assigning a weight value specific to the context or question in response to which the entity was recommended, etc. Next at 1622, the summed weight of the C Corporation is compared to the summed weight of the remaining flow through entities (e.g., all business entities other than the C Corporation without negative recommendations).

If the weight of the C Corporation is greater than the weight of the flow through entities the C Corporation is “designated” as the best business entity for the client's business for year (N) 1624. Otherwise, a flow through entity is “designated” as the best business entity for year (N). Next, as shown in FIG. 15C, types of flow through entities are determined. For example, if the business entity is designated as a flow through entity and stock is sold for funding 1628, the flow through entity will be an S corporation for year (N) 1630. If the business entity is designated as a flow through entity and specific flow through entities have been recommended 1632 and not eliminated in step 1618, it is determined whether more than one specific type of flow through entity was suggested 1634. If only one specific flow through entity has been recommended that flow through entity is preferably the business entity of choice. For example, if an LP or LLC was recommended because of the client's low tolerance for risk 1600 and this was the only specific recommendation, the method will determine that the client should pursue an LP or LLC.

Selection between an LP or LLC may be determined by the client or tax strategist based on client preference or circumstances of each type of entity. However, if more than one specific type of flow through entity was recommended during the process 1634 then it is determined whether any one specific type of flow through entity was recommended more than others 1636. For example, if an, LP or LLC was recommend because of the company is an asset building company 1538 and because the client's risk tolerance is low 1600 and a sole proprietorship was recommended because dependent children will be employed 1604, the selected flow through entity will be the LP or LLC since it has a greater weight 1638.

On the other hand, if two or more specific flow through entities have been recommended the same number of times or have the same weight, the selection between the types of recommended flow through entities may be made by the client, tax strategist or computer 1640, and may take into consideration additional factors, for example, formation and operating expense for each type of recommended business entity, client preference, complexity of each type of business entity, and overall fit for the type of business owned by the client.

If a flow through entity has been designated 1626 and no specific types of flow through entities have been recommend, the flow through entity will be a sole proprietorship 1646 because of the flexibility in changing to other types of business entities in the future. If the sole proprietorship has been eliminated 1618, the default flow through entity will be an LLC. Once the C corporation or type of flow through entity has been determined for year (N), the process may optionally continue to determine business entities for future years 1648, 1650.

The method of selecting business entities 1500 make take into consideration any relevant factors in addition to, or separate from, the specific process described above. For example, if the presence of an asset building company “ABC” recommends an LP/LLC and the income from the ABC increases the marginal rate of the client's personal income tax, a recommendation to consider forming a separate management company as a C Corporation may be indicated. This would allow the ABC structure (a flow through taxation entity) to “upstream” management fees into a C-Corporation thus reducing the taxable flow through income. The C Corporation structure will also allow corporate benefits for the owner. The new management company would also be analyzed using the foregoing process to determine the most appropriate business entity. Additionally, if the exit strategy indicates that a C Corporation should be formed but other factors recommend a flow through entity, the selection may initially be toward a flow through entity with a conversion to a C Corporation in the future.

If a C Corporation is designated 1660 and more than one C Corporation is owned, at least partially, by one individual owner 1662, it may be that the corporations fall under a Controlled Group status 1664. This means that the taxable income would be aggregated and multiple uses of the graduated tax rate is not allowed. Also, there is only one “Section 179” deduction allowed and inter-company sales must be “undone.” Generally, the Controlled Group status is not desirable, as it, in effect, takes multiple corporations and merges them together. If the corporations fall within the Controlled Group status, it is desirable to inquire whether this status can be avoided 1666, and if so, noting actions to avoid brother-sister controlled group status. Controlled Group status may be avoided, or “undone” by causing an unrelated party to own 21% or more of each corporation in the group or by causing a related (by blood) party to own 51% or more.

It should be recognized that the foregoing process is a general assessment to identify an appropriate business entity or entities for a client's business. Consequently, the type of business entity identified by the foregoing process is not necessarily the final selection of a particular business entity for the client's business. The method for selecting a business entity 1500 may or may not consider further input from a user in identifying appropriate business entities. An example of such input may be the whether the client believes the tax benefits of implementing a C corp. are worth the complexities involved in creating and operating a C corporation, etc.

Once the appropriate business entities are identified 1420 (FIG. 14), preferably although not necessarily, using method 1500 for selecting business entities, they are compared to the existing business entities utilized by the client to determine whether any changes should be made or new entities formed 1430. For example, if the client currently uses a sole proprietorship as the business entity for a particular business and the method 1500 indicates that a C Corporation is the preferred entity for that business, the C Corporation is identified as the business entity to be utilized 1440. Alternatively, if method 1500 identifies the sole proprietorship as the most appropriate business entity the business, the SP may be confirmed as the business entity to be utilized 1440.

Once the business entities to be utilized are identified 1440, if necessary, the tax timing for any C Corporations to be utilized is determined 1445. The C Corporation is the only business entity currently allowed to have a business year-end that is not a calendar year end. Through the use of a different year end that other taxable entities, two advantages may be obtained: (1) delaying payment of taxes to the last possible moment generates greater interest on capital; and (2) having more than one tax year end provides more flexibility in allocating extra income between the most appropriate entity. The planning flexibility afforded in having more than one tax year is demonstrated by the following example: A client business has a year end on December 31 and the client's individual year end is by default the same. If for example, on December 15 it is discovered that the income from the business is more than anticipated, the only choice is where the income will be taxed. However, if the business has a year end of, for example, June 30, and the extra income is discover on June 15, the income may be attributed to the corporation and pay the extra tax or distribute it to the owner as salary and have six additional months to pay the tax.

Additional considerations for the tax strategy may include determining what types of tax deference and/or retirement plans the client desires or is eligible for. For example, 401K plans, SEP, Keogh, SARSEP, IRAs, VEBAs and others.

The tax strategy development continues by identifying action items for implementing the tax strategy 652 (FIG. 6). Action items are those actions to be performed in order to reduce the overall tax liability of the client's personal income and income from the client's businesses. Example action items to implement the tax strategy may include any of the following:

Identify/list steps to avoid designation of client business as a QPSC (FIG. 7, 720);

Identify/list steps to avoid designation of client business as a PHC (FIG. 7, 740);

Identify/list steps to separate appreciating assets from company and steps for forming new business entities to own appreciating assets (FIG. 7, 756);

Identify deductible expenses from the Expense Deduction System and determine a system for tracking/recording deductible expenses (FIG. 8);

Identify deductible benefits from the Benefit Deduction System (FIG. 9) and determine benefit implementation requirements if necessary;

Identify and plan for employment of dependents for income splitting (FIG. 10);

Identify and plan for exit strategy (e.g., steps for implementing ESOP, CRT, minority discount program, gifting program; etc.; FIG. 11); and

Identify actions to implement or convert to selected business entities (FIGS. 14-15) and implement tax deference plans (including actions to avoid Controlled Group status).

Action items are not limited to any of the foregoing items and may include any actions necessary for implementing the tax strategy. The tax strategy is presented to the client or designated client representative 655 for review, agreement and/or adjustment. The presentation of the tax strategy may be in paper or electronic form and summarizes the relevant information determined from each of the processes 605-650 including explanations of the identified action items 652. In one embodiment, the tax strategy is presented in a bound booklet provided to the client for the client's review. Preferably, the client reviews the information for accuracy and confirms the acceptability of the developed tax strategy. If however the tax strategy is unacceptable to the client for any particular reason, the developed strategy or any portion thereof may be reconfigured to the satisfaction of the client.

### TAX STRATEGY IMPLEMENTATION.

Implementation of the developed tax strategy preferably includes the steps of: (i) developing a timeline for implementing items; (ii) identifying alliances for implementing the tax strategy; (iii) coordinating with the alliances and allocating tasks to implement the developed tax strategy; and (iv) performing the allocated tasks in accordance with the developed timeline.

For implementation of the developed tax strategy, a timeline for implementing identified action items is developed 660 (FIG. 6). Development of the timeline preferably takes into consideration such factors as the complexity of action items to be performed, the benefits of implementing one action item before another, the requirement for performing certain action items before others and potentially, the availability and feasibility for alliances to perform the action items within a prescribed time period. The timeline for implementing identified action items may be determined at any point after action items have been identified. For example the timeline for implementing action items may be determined as part of the tax strategy development or after coordinating with alliances for implementation of the tax strategy.

Next, alliances for the client to implement the developed tax strategy are identified 665 if not already known. This determination includes identifying people, professionals and/or companies to assist with the details of the client's businesses and developed tax strategy. As previously mentioned, such individuals may include attorneys, accountants, company officers, or any group of people that will be involved in implementing and maintaining the tax strategy.

Once the alliances are identified 665, the client and/or tax strategist coordinate with the alliances and allocate action items to be performed by each alliance. By way of example, this coordination may include preparing formal paperwork for business entity formation/conversion for alliance and client signatures, revising the developed timeline if necessary, developing a chart of accounts for the business entities, coaching the client's bookkeeper/accountant for implementation of the chart of accounts, and recording the allocation of specific action items for each alliance. In a computer implementation of the present invention, software may be configured to suggest professionals to perform each action item. The suggestion may be generalized such as, attorney, accountant, manager; or the suggestion may specifically name attorneys, accountants, bookkeepers, books or websites. For example, a generalized suggestion may include the following comment: “Consult a corporate attorney for details on how to create a C corporation.” An example specific suggestion may include “For more information on forming a C corporation, consult the world wide web at corporation@corporation.tld.” The software may also be configured to provide step-by-step instructions for the client or client alliances to implement the action items.

Once the identified action items are allocated to the client and/or client alliances, the action items for the tax strategy are implemented in accordance with the developed timeline 672.

### TAX STRATEGY MAINTENANCE

Maintaining the implemented tax strategy preferably includes: (i) calculating benefits of the tax strategy implementation on a periodic basis; (ii) reviewing the tax strategy for changes in benefits, personal circumstances and/or tax regulations; (iii) revising or adjusting the tax strategy if necessary; and (iv) coaching or informing the client and/or alliances on changes when the implemented tax strategy is revised/adjusted.

The benefits of the implemented tax strategy should be calculated on a periodic basis 675, for example, monthly. Calculating the benefits of the implemented tax strategy preferably includes: (i) determining/projecting the client's personal income and business income from each owned business entity based on company financial statements and the client's personal income; (ii) calculating the annualized tax for business and personal income based on the implemented tax strategy; (iii) calculating the annualized tax for business and personal income based on the client's old system (i.e., before implementation of the tax strategy); and (iv) comparing (ii) to (iii) to determine the tax benefits of the implemented tax strategy. If the annualized tax for the implemented tax strategy is less than the annualized tax for the old system, there is a tax benefit. Any indicia of tax liability other than the annualized tax may also be used to track tax benefit, for example, marginal tax rates.

Next, the implemented tax strategy is reviewed for tax benefit, fit to client circumstances and/or compliance with tax regulations 680. The tax benefits calculated in step 675 are compared with previously calculated or estimated tax benefit to determine whether any significant changes may have occurred. The amount of the tax benefit from the implemented tax strategy should either remain the same or increase during the periodic reviews. In the event the tax benefit decreases or is no longer present during a periodic review, the client's tax strategy may require revisions or adjustments 685.

Revisions or adjustments to the tax strategy 685 may include performing one or more of the tax strategy development processes 605-650 again. Similar to the process discussed in reference to FIG. 5, if changes in the client's personal/business circumstances or changes in tax laws may affect the currently implemented tax strategy, the tax strategy may be revised or adjusted.

Revising or adjusting the tax strategy may involve performing one or more of any of the previously discussed processes using information from the changes in circumstances. When the tax strategy is changed or adjusted, it is important to coach the client and client alliances on the changes to ensure that the new changes are properly implemented and tracked 690. Coaching the client's bookkeeper in proper accounting and procedures for any tax strategy revisions is beneficial in obtaining maximum effectiveness.

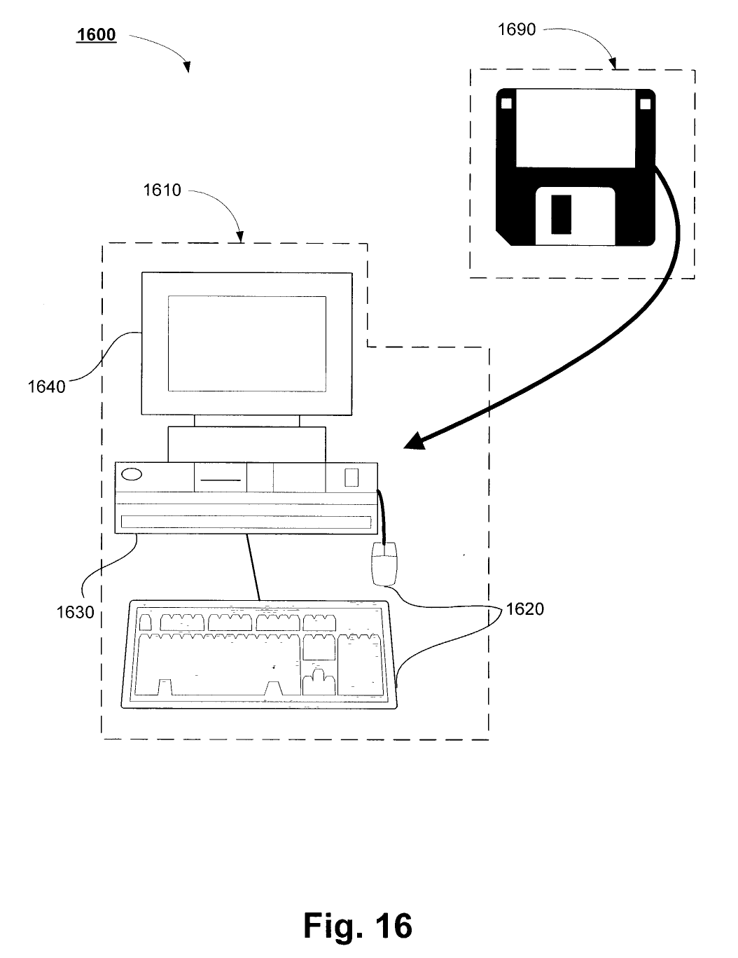

Referring to FIG. 16, a computer based system for reducing taxes 1600 includes a hardware component 1610 and a software or firmware component 1690. The hardware component preferably includes: (i) an input device 1620 for inputting taxpayer information; (ii) a processing device 1630 for processing the inputted taxpayer information and performing processes described above; (iii) a storage device (not separately shown) for storing the taxpayer and processed information; and (iv) an output device 1640 for outputting or displaying information. The software or firmware component 1690 preferably includes machine readable code stored on a tangible medium, that when executed by the processing device, instructs the processing device to process, compare, retrieve, output and/or store information relating to the processes described herein.

Input device 1620 may be any device or combination of devices for facilitating input of taxpayer information including, but not limited to, a keyboard, mouse, microphone, or scanner. Processing device 1630 may be any portable or fixed device, or combination of devices, capable of retrieving inputted data, processing data and generating an output including, but not limited to, a microprocessor, micro-controller, or programmable logic array. The storage device may be any single memory device or combination of memory devices capable of storing information including, but not limited to, a fixed RAM or ROM, or hard drive as well as any removable storage device(s) such as an optical, magnetic or electronic memory device(s). Output device 1640 is one or more devices capable of displaying an output generated by the processing device including, but not limited to, a printer, a CRT, a LCD, a speaker, or a plasma display.

The machine-readable code of software component 1690 may be stored on any tangible medium and programmed using any known or existing computer language to perform the functions outlined above. Using computer based system 1600, a client/tax professional may quickly input taxpayer information, process the information to determine results and store all information in a memory accessible by processing device 1630. Software component 1690 may also include machine-readable code for assisting user in navigating and learning the methods disclosed herein. Such code may be implemented using retrievable “help files” and/or as an automated tutorial process for guiding a user through each action/input.

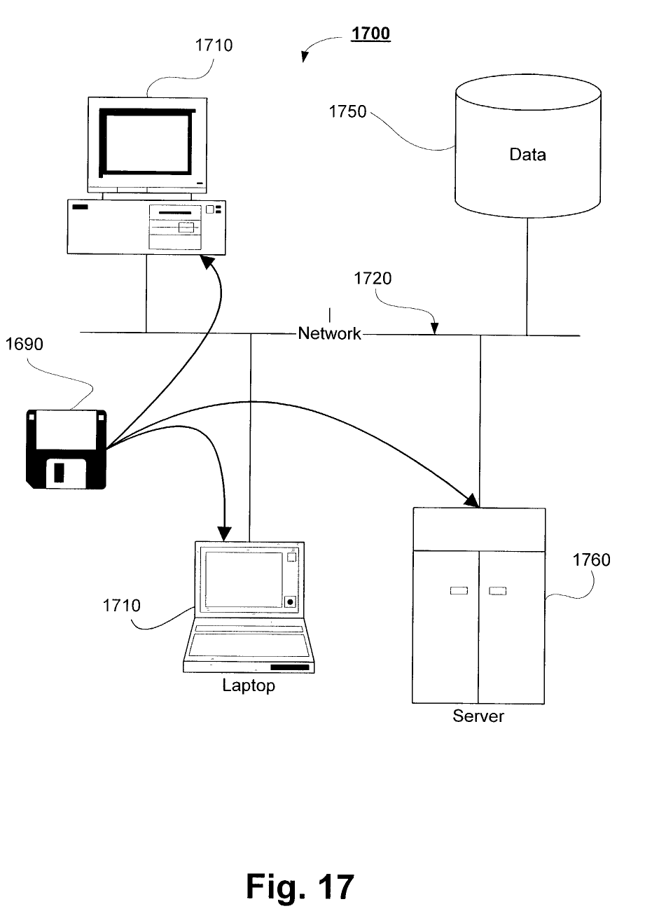

Referring to FIG. 17, a network system 1700 for universal reduction of taxes may include: (i) one or more terminals 1710 (which may or may not include all of the hardware components discussed above in respect to system 1610); (ii) a communications network 1720, such as a LAN or WAN (e.g., intranet or Internet); (iii) an external data storage device (e.g., network or server accessible database) 1750; and (iv) a network computing device 1760 (which may perform any required processing, retrieval, storage and output functions). Network 1700, is preferably configured and operable to enable a taxpayer/client to input data (e.g., at terminal 1710) for processing at centralized and/or distant location (e.g., server 1760). Additionally network 1700 may preferably store taxpayer information and/or results of the processed information at a centralized location (e.g., database 1150). Depending on the requirements and/or desires of the client/tax strategist, software component 1690 may be configured as a distributed program, i.e., having various components of the software residing on various network devices.

Unless contrary to physical possibility, the inventor envisions the methods and systems described herein: (i) may be performed in any sequence and/or combination; and (ii) the components of respective embodiments combined in any manner. Unless expressly stated, actions and steps set forth in the claims are not limited to any particular sequence.

It should be recognized that the information and options discussed in this disclosure specifically focus on current laws and regulations in the United States and that the invention may also be adapted and effectively applied to tax and business regulations that have changed and to the specific laws and regulations of any jurisdiction including individual states of the U.S. and of the foreign nations of the world. Consequently, although there have been described preferred embodiments of this novel invention, many variations and modifications are possible and the embodiments described herein are not limited by the specific disclosure above, but rather should be limited only by the scope of the appended claims.

1. A method for reducing a tax burden comprising:
developing a tax strategy to determine a projected tax;
facilitating implementation of the tax strategy;
reviewing results of the implemented tax strategy for changes in at least one of taxpayer circumstances and tax laws; and
determining whether to update the tax strategy based on the reviewed results.

2. The method of claim 1 wherein developing the tax strategy comprises:
collecting taxpayer information using a uniform series of questions.

3. The method of claim 2 wherein the uniform series of questions is presented in an electronic format.

4. The method of claim 2 wherein the uniform series of questions is presented in a paper format.

5. The method of claim 2 wherein the uniform series of questions is presented in a verbal format.

6. The method of claim 1 wherein developing the tax strategy comprises:
processing taxpayer information to determine a suggested tax strategy.

7. The method of claim 6 wherein processing taxpayer information comprises:
characterizing at least one of taxpayer income and assets.

8. The method of claim 6 wherein processing taxpayer information comprises:
determining one or more potential deductions from one or more expenses qualifying as an ordinary and necessary expense.

9. The method of claim 6 wherein processing taxpayer information comprises:
determining one or more potential deductions based on benefits provided by a business.

10. The method of claim 6 wherein processing taxpayer information comprises:
determining whether taxpayer income may be moved to a lower taxed entity.

11. The method of claim 6 wherein processing taxpayer information comprises:
determining an exit strategy for a taxpayer to exit a business.

12. The method of claim 6 wherein processing taxpayer information comprises:
evaluating funding sources for a taxpayer business.

13. The method of claim 6 wherein processing taxpayer information comprises:
assessing at least one of a taxpayer's tolerance for risk, potential personal risks to a taxpayer's business assets, and potential business risks to a taxpayer's personal assets.

14. The method of claim 6 wherein processing taxpayer information comprises:
evaluating business entities based on the taxpayer information.

15. The method of claim 1 wherein developing the tax strategy comprises:
determining action items to implement a suggested tax strategy.

16. The method of claim 1 wherein facilitating implementation of the tax strategy comprises:
developing a list of specific steps to implement the action items; and
determining a timeline for performing the specific steps.

17. The method of claim 16 wherein facilitating implementation of the tax strategy further comprises:
coordinating the specific steps and the timeline with at least one of a taxpayer and the taxpayer's representative.

18. The method of claim 1 wherein facilitating implementation of the tax strategy comprises:
coaching at least one of the taxpayer and a taxpayer's representative in tax related accounting coding, expensing and record keeping for the tax strategy.

19. The method of claim 1 wherein reviewing results of the implemented tax strategy comprises:
reviewing, on a periodic basis, the taxpayer's financial statements for accuracy and adherence to the tax strategy;
determining an actual tax based on the reviewed financial statements; and
comparing the actual tax with the projected tax.

20. The method of claim 1 wherein reviewing results of the implemented tax strategy comprises:
periodically evaluating whether the tax strategy complies with current laws and regulations.

21. The method of claim 20 wherein periodically evaluating further comprises evaluating whether the tax strategy takes advantage of changes in current laws and regulations.

22. The method of claim 19 wherein determining whether to update the tax strategy comprises at least one of:
evaluating whether the actual tax differs from the projected tax by greater than a predetermined amount;
evaluating whether a financial status of the taxpayer has changed by more than a certain amount since the implementation of the tax strategy; and
evaluating whether a cost of developing and implementing a new tax strategy outweighs a cost of continuing with the tax strategy.

23. A method for reducing a tax burden comprising:
collecting taxpayer information using a uniform series of questions;
developing a tax strategy using the collecting taxpayer information to determine an estimated tax;
facilitating implementation of the tax strategy;
reviewing results of the implemented tax strategy; and
determining whether to update the tax strategy based on the reviewed results.

24. A method for reducing a tax burden comprising:
collecting taxpayer information;
processing the collected information to determine a suggested tax strategy;
implementing the suggested tax strategy;
reviewing result of the implemented tax strategy for changes in at least one of taxpayer circumstances and tax laws; and
determining whether to update the tax strategy based on the reviewed results.

25. A method of developing a tax strategy for a taxpayer, the method comprising:
obtaining taxpayer information; and
characterizing the taxpayer's income and assets using the obtained taxpayer information.

26. The method of claim 25 further comprising:
determining potential tax deductions available to the taxpayer.

27. The method of claim 26 wherein determining potential tax deduction comprises at least one of: (i) identifying taxpayer expenses that may qualify as deductions, and (ii) identifying potentially deductible benefits that may be provided by a taxpayer's business.

28. The method of claim 25 further comprising:
determining whether taxpayer income may be accounted to a different entity, wherein said different entity has a lower marginal tax rate than the taxpayer.

29. The method of claim 25 further comprising:
identifying an exit strategy for the taxpayer to exit a business.

30. The method of claim 25 further comprising:
assessing at least one of (i) a taxpayer's tolerance for risk; (ii) a taxpayer's personal risks to business assets; and (iii) business risks to personal assets of the taxpayer.

31. The method of claim 25 further comprising:
evaluating potential business structures based on the obtained taxpayer information; and
identifying at least one business structure for utilization by the taxpayer based on the evaluation.

32. The method of claim 25 wherein characterizing the taxpayer's income and assets comprises:
determining whether a taxpayer's business is one of a qualified personal service company and a personal holding company; and
identifying actions, if any, that may be taken to remove the taxpayer's business as being the qualified personal service company or the personal holding company.

33. The method of claim 25 wherein characterizing the taxpayer's income and assets comprises:
determining an amount of projected income for the taxpayer's business;
identifying an amount of the projected income that is earned income; and
identifying appreciating assets of the taxpayer's business that are separable from the business.

34. The method of claim 27 wherein identifying taxpayer expenses that may qualify as deductions comprises:
comparing taxpayer expenditures with a list of accepted deductible ordinary and necessary business expenses; and
identifying taxpayer expenditures eligible for deduction based on the comparison.

35. The method of claim 34 wherein identifying taxpayer expenses that may qualify as deductions further comprises:
summing the identified taxpayer expenditures to determine a total expense deduction.

36. The method of claim 27 wherein identifying potentially deductible benefits that may be provided by a taxpayer's business comprises:
comparing benefits that may be provided by the taxpayer's business with a list of employer benefit deductions available under current law; and
identifying those benefits that may be provided by the taxpayer that are eligible for deduction based on the comparison.

37. The method of claim 34 wherein comparing and identifying taxpayer expenditures are performed by a processing device executing machine readable code.

38. The method of claim 36 wherein comparing and identifying benefits is performed by a processing device executing machine readable code.

39. The method of claim 28 wherein determining whether taxpayer income may be accounted to the different entity comprises:
identifying taxpayer dependents and companies held by a C corporation that may be eligible to be compensated by the taxpayer for performing tasks on behalf of the taxpayer; and
designating a compensation for the identified taxpayer dependents and companies held by the C corporation that is reasonable for the tasks to be performed.

40. The method of claim 25 further comprising:
evaluating funding sources for a taxpayer's business.

41. The method of claim 40 wherein evaluating funding sources comprises:
identifying whether funding will be needed for the taxpayer's business; and if so:
identifying what percentage of business funding will be provided by the taxpayer and what percentage of business funding will be provided by a third party;
identifying an accounting type for business funding;
identifying whether business funding will come from public investment; and
identifying ownership rights between taxpayer and the third party.

42. The method of claim 41 further comprising:
evaluating identified information to determine one or more appropriate business structures.

43. The method of claim 29 wherein identifying the exit strategy comprises:
identifying whether the taxpayer will exit the business through one of an asset sale, a stock sale, a gift and closing.

44. The method of claim 43 wherein if the exit strategy is identified to be the asset sale, the method further comprises:
identifying whether assets will be sold to family, employees or outsiders; and
if sold to family, determining whether a minority discount is available for assets sold at less than fair market value; else,
if sold to employees, determining whether an earned discount is applicable for assets sold at less than fair market value due to employee service.

45. The method of claim 43 wherein if the exit strategy is identified to be the stock sale, the method further comprises:
identifying whether stock will be sold publicly, to outsiders or to employees; and
if sold to outsiders, determining whether the business may be a qualified small business corporation; or
if sold to employees, determining whether one of an employee stock option plan and an earned discount is applicable.

46. The method of claim 43 wherein if the exit strategy is identified to be the gift, the method further comprises:
determining whether the gift will be to family or to charity; and
if gifted to family, determining whether the gift will be a long term gift or an immediate gift; or
if gifted to charity, determining whether a charitable trust is applicable.

47. The method of claim 30 wherein assessing the taxpayer's tolerance for risk comprises:
soliciting the taxpayer to provide answers to a risk tolerance quiz.

48. The method of claim 30 wherein assessing the taxpayer's personal risks comprises:
identifying personal circumstances of the taxpayer that pose a potential risk to assets of the taxpayer's business;
assigning a weight to each identified personal circumstance; and
determining an overall personal risk based on the assigned weights.

49. The method of claim 30 wherein assessing business risks to personal assets of the taxpayer comprises:
identifying business circumstances that may pose a potential risk to the taxpayer's personal assets;
assigning a weight to each business circumstance identified; and
determining an overall business risk based on the assigned weights.

50. The method of claim 31 wherein evaluating potential business structures comprises:
processing the obtained taxpayer information using a business entity formula to determine at least one recommended business entity; and
comparing one or more business entities presently used by the taxpayer with the at least one recommended business entity.

51. The method of claim 50 wherein processing is performed by a processing device executing machine readable code.

52. A computer program product for recommending one or more business entities for utilization by a taxpayer based on inputted taxpayer information, the computer program product comprising machine readable code stored on a tangible medium, wherein the machine readable code comprises code for:
considering potential tax deductions of a taxpayer's expenses and deductible benefits that may be provided by a business owned by the taxpayer; and
determining a first tax rate for the business as a flow through entity and a second tax rate for the business as a C corporation. considering an exit strategy for exiting the business; and.

53. The computer program product of claim 52 further comprising machine readable code for:
considering a characterization of taxpayer income and assets.

54. The computer program product of claim 52 further comprising machine readable code for:
considering an exit strategy for exiting the business.

55. The computer program product of claim 52 further comprising machine readable code for:
considering a type of funding for the business.

56. The computer program product of claim 52 further comprising machine readable code for:
considering a characterization of taxpayer income and assets;
considering an exit strategy for exiting the business; and
considering a type of funding for the business.

57. The computer program product of claim 56 further comprising machine readable code for:
processing considered information to recommend one or more business structures; and
outputting the one or more recommended business structures.

58. A computer program product for reducing a taxpayer's taxes comprising machine readable code stored on a tangible medium, the machine readable code comprising:
code for accepting input of the taxpayer's information;
code for determining potential tax deductions for taxpayer expenditures based on a comparison of the taxpayer expenditures with a list of ordinary and necessary expenses.

59. The computer program product of claim 58 wherein the machine readable code further comprises:
code for determining potential benefit tax deductions for benefits provided by a business owned by the taxpayer; and
code for assisting the taxpayer in determining whether earned income may be accounted to a different entity.

60. The computer program product of claim 58 wherein the machine readable code further comprises:
code for determining a marginal tax rate for a taxpayer's business and the taxpayer; and
code for assisting the taxpayer in determining an exit strategy.

61. The computer program product of claim 58 wherein the machine readable code further comprises:
code for performing a risk analysis of at least one of a personal risk, a business risk and a tolerance for the taxpayer to risk.

62. The computer program product of claim 58 wherein the machine readable code further comprises:
code for recommending at least one business entity based on input of the taxpayer's information.

63. The computer program product of claim 58 wherein the machine readable code further comprises:
code for identifying action items for reducing the taxpayer's taxes.

64. The computer program product of claim 58 wherein the computer program product comprises a distributed computer program having components thereof stored in at least two different locations.

65. A system for reducing a tax burden comprising:
input means for allowing a taxpayer to input information; and
processing means for processing the taxpayer's information to determine a suggested tax strategy.

66. The system of claim 65 wherein the processing means comprises a processing device executing machine readable code.

67. The system of claim 65 wherein the input means comprises a worksheet.

68. The system of claim 67 wherein the worksheet comprises a questionnaire represented on one or more sheets of paper.

69. The system of claim 67 wherein the worksheet comprises a questionnaire represented by pixels displayed on a display device.
